(19) United States
(12) Patent Application Publication
(10) Pub. No.: US 2026/0181245 A1
(43) Pub. Date: Jun. 25, 2026

(54) METHOD AND APPARATUS FOR MANAGEMENT OF RESOURCE CONSUMPTION OF CAMERAS

(71) Applicant: GENETEC INC., SAINT-LAURENT (CA)

(72) Inventors: SAMAH MANSOUR, SAINT-LAURENT (CA); JEAN-YVES PIKULIK, SAINT-LAURENT (CA); PABLO CASSANI, SAINT-LAURENT (CA)

(73) Assignee: GENETEC INC., SAINT-LAURENT, QC (CA)

(21) Appl. No.: 19/124,541

(22) PCT Filed: Oct. 27, 2023
(86) PCT No.: PCT/CA2023/051439

§ 371 Date: Apr. 25, 2025

Related U.S. Application Data
(60) Provisional application No. 63/419,752, filed on Oct. 27, 2022.

(51) Int. Cl. H04N 23/63; H04N 23/65; H04N 23/90

(52) U.S. Cl. CPC H04N 23/632; H04N 23/651; H04N 23/90

(57) ABSTRACT

A method of operating a computing apparatus communicatively coupled to a set of one or more cameras. The method includes monitoring a resource consumption mode of operation each of the cameras and changing the resource consumption mode of operation of one or more target cameras in the set of one or more cameras from a first resource consumption mode of operation to a second resource consumption mode of operation. The first and second resource consumption modes of operation are respectively a low and a high resource consumption mode of operation. The resource may be power or data utilized by the cameras. The target cameras are selected based on an event characteristic detected by the computing apparatus. The method may be carried out by a processor of a computing apparatus. A non-transitory computer readable medium may store instructions for causing the processor of the computing apparatus carry out the method.

### FIELD

The present disclosure relates generally to cameras and, more specifically, to managing the consumption of resources such as power and data by cameras.

### BACKGROUND

The use of cameras, such as on-grid cameras and off-grid cameras, is increasingly commonplace to capture suspicious events happening in neighborhoods.

Typically, better response outcomes can be achieved when events are captured by one or more cameras with operating parameters configured for increased probability that valuable information can be extracted from the images, videos or audio recorded by the camera and for rapid transmission to a communicatively connected to a computer (e.g., a video management server) as this leads to improved identification, localization and classification of suspicious activity.

However, because of certain tradeoffs associated with operating cameras in this fashion, it may not be feasible to operate the cameras in this way all the time. For instance, because of the costs incurred by data consumption by the cameras and memory storage requirements associated with data consumption by the cameras, it is not feasible, from a data consumption perspective, to operate an entire field of cameras to rapidly transmit data to a computer all the time. Additionally, because off-grid cameras are battery-powered, it is not feasible, from a power consumption perspective, to operate an entire field of off-grid cameras in high-grade video capture mode all the time.

Thus, a data and power-sensitive solution for event detection and analysis would be desirable when operating cameras which may be positioned to capture such events.

### SUMMARY

The present disclosure provides a method and system for operating an off-grid camera or an on-grid camera that has the ability to operate in several power modes, including a low power mode and a high power mode. A processing entity is configured to detect an event characteristic and to force the camera to operate in a chosen mode of operation in response to the detected trigger. According to a first example aspect, there is provided a method of operating a computing apparatus communicatively coupled to a set of one or more cameras. The method comprises: monitoring a resource consumption mode of operation each of the cameras; and changing the resource consumption mode of operation of one or more target cameras in the set of one or more cameras from a first resource consumption mode of operation to a second resource consumption mode of operation, the target cameras being selected based on an event characteristic detected by the computing apparatus, the first resource consumption mode of operation being a low resource consumption mode of operation and the second resource consumption mode of operation being a high resource consumption mode of operation.

In accordance with any of the preceding aspects, each of the cameras in the set of one or more cameras comprises:
an audiovisual (AV) generation system configured to generate at least one of images or videos or audio, the AV generation system comprising at least one of an image capture device configured to capture images or an audio capture device configured to capture audio, the AV generation system further comprising a processing entity configured to process at least one of the captured images or the captured video or the captured audio; and
a network interface operable to transmit to the computing apparatus at least one of the images or videos or the audio generated by cameras in the set of one or more cameras.

In accordance with any of the preceding aspects, the one or more target cameras include at least one of an on-grid camera or an off-grid camera.

In accordance with any of the preceding aspects, the low resource consumption mode of operation is a low data consumption mode of operation and the high resource consumption mode of operation is a high data consumption mode of operation.

In accordance with any of the preceding aspects, when a given one of the one or more target cameras is in the high data consumption mode, the given one of the one or more target cameras consumes more wireless data than in low data consumption mode.

In accordance with any of the preceding aspects, the network interface of the given one of the one or more target cameras is operable to transmit to the computing apparatus at least one of (i) images generated by the given one of the one or more target; (ii) videos generated by the given one of the one or more target; or (iii) audio generated by the given one of the one or more target, in accordance with at least one data consumption parameter that affects wireless data utilization by the given one of the one or more target cameras.

In accordance with any of the preceding aspects, the at least one data consumption parameter comprises at least one of a data transmission setting indicative of whether real-time data transmission to the computing apparatus is enabled, a data consumption setting indicative of whether wireless data consumption is enabled, a threshold limit for an amount of data consumable over a given time period, bandwidth, transmission duty cycle, modulation scheme, data rate and latency.

In accordance with any of the preceding aspects, changing the resource consumption mode of operation from a low data consumption mode of operation to a high data consumption mode of operation comprises at least one of (i) decreasing a latency used by the network interface to transmit the generated images or audio to the computing apparatus (ii) enabling real-time data transmission to the computing apparatus or wireless data consumption by the network interface to transmit the generated images or videos or audio to the computing apparatus (iii) increasing a threshold limit for an amount of data consumed over a given time period, a bandwidth, a transmission duty cycle and/or a data rate used by the network interface to transmit the generated images or videos or audio to the computing apparatus; or (iv) changing a modulation scheme used by the network interface to transmit the generated images or videos or audio to the computing apparatus.

In accordance with any of the preceding aspects, the one or more target cameras are off-grid cameras.

In accordance with any of the preceding aspects, each off-grid camera includes a replenishable power supply.

In accordance with any of the preceding aspects, the replenishable power supply comprises an off-grid power supply.

In accordance with any of the preceding aspects, the low resource consumption mode of operation is a low power consumption mode of operation and the high resource consumption mode of operation is a high power consumption mode of operation.

In accordance with any of the preceding aspects, when a given one of the one or more target cameras is in the high power consumption mode of operation, the given one of the one or more target cameras consumes more power from the off-grid power supply than during the low power consumption mode of operation.

In accordance with any of the preceding aspects, when a given one of the one or more target cameras is in the lower power consumption mode of operation, the given one of the one or more target cameras is configured to capture still images; and when the given one of the one or more target cameras is in the high power consumption mode of operation, the given one of the one or more target cameras is configured to capture video.

In accordance with any of the preceding aspects, the AV generation system of the given one of the one or more target cameras is operable to generate at least one of images or videos or audio in accordance with at least one power consumption parameter that affects power utilization by the given one of the one or more target cameras.

In accordance with any of the preceding aspects, the at least one power consumption parameter comprises at least one of an image capture activation setting indicative of whether image or video capture is enabled, an audio capture activation setting indicative of whether audio capture is enabled, frame rate, image resolution, number of images captured over a given time period, activation of flash, a brightness of flash, a sampling rate, a detection rate, a compression ratio, and a threshold limit of acceptable false positive detections.

In accordance with any of the preceding aspects, changing from a low power consumption mode of operation to a high power consumption mode of operation comprises at least one of (i) enabling image capture, enabling video capture, enabling audio capture; (ii) increasing a frame rate, an image resolution, a number of images captured over the given time period, a brightness of flash, an activation of flash, and/or a sampling rate used by the AV generation system to generate images or videos or audio; (iii) increasing a detection rate or the threshold limit of acceptable false positive detections used by the processing entity to process the generated images or the generated videos or the generated audio; or (iv) decreasing a data compression ratio used by the AV generation system to generate images or videos or audio.

In accordance with any of the preceding aspects, the processing entity of a given one of the one or more target cameras is configured for carrying out first-level processing of captured images or videos or audio to create a result, wherein when the given one of the one or more target cameras is in the high power consumption mode of operation, the processing entity is configured for performing second-level processing on the result of the first-level processing and for sending a result of the second-level processing to the computing apparatus via the wireless network interface, and wherein when the given one of the one or more target cameras is in the low power consumption mode of operation, the processing entity is configured for sending the result of the first-level processing to the computing apparatus via the wireless network interface without performing the second-level processing on the result of the first-level processing.

In accordance with any of the preceding aspects, the event characteristic is detected by the computing apparatus based on at least one of: (i) responding to contents of images or videos or audio captured by a given one of the cameras in the set of one or more cameras; (ii) responding to a result received from a given one of the set of one or more cameras, the result created by the given one of the cameras in the set of one or more cameras further to the processing entity of the given one of the cameras in the set of one or more cameras carrying out processing of captured images or captured video or captured audio; or (iii) responding to a backend input received by the computing apparatus.

In accordance with any of the preceding aspects, the result comprises a license plate detection, an object detection or a gunshot detection.

In accordance with any of the preceding aspects, the backend input comprises an input indicative of a computer-aided dispatch call, a call received from an emergency service or an AMBER (America's Missing: Broadcast Emergency Response) Alert.

In accordance with any of the preceding aspects, the event characteristic detected by the computing apparatus includes one of a location, a location of an object, a direction of travel of an object and a speed of travel of an object.

In accordance with any of the preceding aspects, the target cameras are those cameras of the set of one or more cameras whose field of view or whose pickup range is in within a threshold distance of the location or of the object.

In accordance with any of the preceding aspects, changing the resource consumption mode of operation of a given one of the one or more target cameras is carried out irrespective of a battery charge level of the given one of the one or more target cameras.

In accordance with any of the preceding aspects, changing the resource consumption mode of operation of a given one of the one or more target cameras is carried out irrespective of a data consumption level of the given one of the one or more target cameras.

In accordance with any of the preceding aspects, the method further comprises: for a given one of the one or more target cameras, changing the resource consumption mode of operation from the high consumption mode of operation to the low consumption mode of operation based on a relinquish condition determined to having been met by the computing apparatus and controlling at least one resource consumption parameter of the given one of the one or more target cameras to change the resource consumption mode of operation from the high consumption mode of operation to the low consumption mode of operation.

In accordance with any of the preceding aspects, the relinquish condition having been met comprises a given amount of time having elapsed.

In accordance with any of the preceding aspects, the method further comprises: receiving an input from a given one of the one or more target cameras indicative of a change from the high consumption mode of operation to the low consumption mode operation further to a determination by the given one of the one or more target cameras that a relinquish condition has been met and updating a resource consumption mode database stored in a memory of the computing apparatus.

In accordance with any of the preceding aspects, the event characteristic detected by the computing apparatus is an anticipated trajectory of at least one object, wherein the one or more target cameras are those cameras in the set of one or more cameras whose field of view is traversed by the anticipated trajectory.

In accordance with any of the preceding aspects, the method further comprises: computing a scheduled time at which to change the resource consumption mode for each of the one or more target cameras.

In accordance with any of the preceding aspects, changing the resource consumption mode of operation of the one or more target cameras comprises sending a command to the each of the one or more target cameras to change the resource consumption mode of operation at the scheduled time.

In accordance with any of the preceding aspects, the method further comprises: monitoring images or video or audio generated by a given one of the one or more of target cameras to determine if a condition is met and sending a command to the given one of the one or more target cameras to change the resource consumption mode of operation from the high resource consumption mode of operation to the low resource consumption mode of operation if the condition is met.

In accordance with any of the preceding aspects, the condition comprises the object no longer being in the field of view of the given one of the one or more target cameras.

According to a second example aspect, there is provided a non-transitory computer-readable medium storing instructions which, when read and executed by a processor of a computing apparatus communicatively coupled to a set of one or more cameras, cause the processor to carry out a method that comprises: monitoring a resource consumption mode of operation of each of the cameras; and changing the resource consumption mode of operation of one or more target cameras in the set of one or more cameras from a first resource consumption mode of operation to a second resource consumption mode of operation, the target cameras being selected based on an event characteristic detected by the computing apparatus, the first resource consumption mode of operation being a low resource consumption mode of operation and the second resource consumption mode of operation being a high resource consumption mode of operation.

In accordance with any of the preceding aspects, the one or more target cameras include at least one of an on-grid camera or an off-grid camera.

In accordance with any of the preceding aspects, the low resource consumption mode of operation is a low data consumption mode of operation and the high resource consumption mode of operation is a high data consumption mode of operation.

In accordance with any of the preceding aspects, when a given one of the one or more target cameras is in the high data consumption mode, the given one of the one or more target cameras consumes more wireless data than in low data consumption mode.

In accordance with any of the preceding aspects, the network interface of the given one of the one or more target cameras is operable to transmit to the computing apparatus at least one of (i) images generated by the given one of the one or more target; (ii) videos generated by the given one of the one or more target; or (iii) audio generated by the given one of the one or more target, in accordance with at least one data consumption parameter that affects wireless data utilization by the given one of the one or more target cameras.

In accordance with any of the preceding aspects, the at least one data consumption parameter comprises at least one of a data transmission setting indicative of whether real-time data transmission to the computing apparatus is enabled, a data consumption setting indicative of whether wireless data consumption is enabled, a threshold limit for an amount of data consumable over a given time period, bandwidth, transmission duty cycle, modulation scheme, data rate and latency.

In accordance with any of the preceding aspects, changing the resource consumption mode of operation from a low data consumption mode of operation to a high data consumption mode of operation comprises at least one of (i) decreasing a latency used by the network interface to transmit the generated images or audio to the computing apparatus (ii) enabling real-time data transmission to the computing apparatus or wireless data consumption by the network interface to transmit the generated images or videos or audio to the computing apparatus (iii) increasing a threshold limit for an amount of data consumed over a given time period, a bandwidth, a transmission duty cycle and/or a data rate used by the network interface to transmit the generated images or videos or audio to the computing apparatus; or (iv) changing a modulation scheme used by the network interface to transmit the generated images or videos or audio to the computing apparatus.

In accordance with any of the preceding aspects, the one or more target cameras are off-grid cameras.

In accordance with any of the preceding aspects, each off-grid camera includes a replenishable power supply.

In accordance with any of the preceding aspects, the replenishable power supply comprises an off-grid power supply.

In accordance with any of the preceding aspects, the low resource consumption mode of operation is a low power consumption mode of operation and the high resource consumption mode of operation is a high power consumption mode of operation.

In accordance with any of the preceding aspects, when a given one of the one or more target cameras is in the high power consumption mode of operation, the given one of the one or more target cameras consumes more power from the off-grid power supply than during the low power consumption mode of operation.

In accordance with any of the preceding aspects, when a given one of the one or more target cameras is in the lower power consumption mode of operation, the given one of the one or more target cameras is configured to capture still images; and when the given one of the one or more target cameras is in the high power consumption mode of operation, the given one of the one or more target cameras is configured to capture video.

In accordance with any of the preceding aspects, the AV generation system of the given one of the one or more target cameras is operable to generate at least one of images or videos or audio in accordance with at least one power consumption parameter that affects power utilization by the given one of the one or more target cameras.

In accordance with any of the preceding aspects, the at least one power consumption parameter comprises at least one of an image capture activation setting indicative of whether image or video capture is enabled, an audio capture activation setting indicative of whether audio capture is enabled, frame rate, image resolution, number of images captured over a given time period, activation of flash, a brightness of flash, a sampling rate, a detection rate, a compression ratio, and a threshold limit of acceptable false positive detections.

In accordance with any of the preceding aspects, changing from a low power consumption mode of operation to a high power consumption mode of operation comprises at least one of (i) enabling image capture, enabling video capture, enabling audio capture; (ii) increasing a frame rate, an image resolution, a number of images captured over the given time period, a brightness of flash, an activation of flash, and/or a sampling rate used by the AV generation system to generate images or videos or audio; (iii) increasing a detection rate or the threshold limit of acceptable false positive detections used by the processing entity to process the generated images or the generated videos or the generated audio; or (iv) decreasing a data compression ratio used by the AV generation system to generate images or videos or audio.

In accordance with any of the preceding aspects, the processing entity of a given one of the one or more target cameras is configured for carrying out first-level processing of captured images or videos or audio to create a result, wherein when the given one of the one or more target cameras is in the high power consumption mode of operation, the processing entity is configured for performing second-level processing on the result of the first-level processing and for sending a result of the second-level processing to the computing apparatus via the wireless network interface, and wherein when the given one of the one or more target cameras is in the low power consumption mode of operation, the processing entity is configured for sending the result of the first-level processing to the computing apparatus via the wireless network interface without performing the second-level processing on the result of the first-level processing.

In accordance with any of the preceding aspects, the event characteristic is detected by the computing apparatus based on at least one of: (i) responding to contents of images or videos or audio captured by a given one of the cameras in the set of one or more cameras; (ii) responding to a result received from a given one of the set of one or more cameras, the result created by the given one of the cameras in the set of one or more cameras further to the processing entity of the given one of the cameras in the set of one or more cameras carrying out processing of captured images or captured video or captured audio; or (iii) responding to a backend input received by the computing apparatus.

In accordance with any of the preceding aspects, the result comprises a license plate detection, an object detection or a gunshot detection.

In accordance with any of the preceding aspects, the backend input comprises an input indicative of a computer-aided dispatch call, a call received from an emergency service or an AMBER (America's Missing: Broadcast Emergency Response) Alert.

In accordance with any of the preceding aspects, the event characteristic detected by the computing apparatus includes one of a location, a location of an object, a direction of travel of an object and a speed of travel of an object.

In accordance with any of the preceding aspects, the target cameras are those cameras of the set of one or more cameras whose field of view or whose pickup range is in within a threshold distance of the location or of the object.

In accordance with any of the preceding aspects, changing the resource consumption mode of operation of a given one of the one or more target cameras is carried out irrespective of a battery charge level of the given one of the one or more target cameras.

In accordance with any of the preceding aspects, changing the resource consumption mode of operation of a given one of the one or more target cameras is carried out irrespective of a data consumption level of the given one of the one or more target cameras.

In accordance with any of the preceding aspects, the processer is further caused to: for a given one of the one or more target cameras, changing the resource consumption mode of operation from the high consumption mode of operation to the low consumption mode of operation based on a relinquish condition determined to having been met by the computing apparatus and controlling at least one resource consumption parameter of the given one of the one or more target cameras to change the resource consumption mode of operation from the high consumption mode of operation to the low consumption mode of operation.

In accordance with any of the preceding aspects, the relinquish condition having been met comprises a given amount of time having elapsed.

In accordance with any of the preceding aspects, the processer is further caused to: receiving an input from a given one of the one or more target cameras indicative of a change from the high consumption mode of operation to the low consumption mode operation further to a determination by the given one of the one or more target cameras that a relinquish condition has been met and updating a resource consumption mode database stored in a memory of the computing apparatus.

In accordance with any of the preceding aspects, the event characteristic detected by the computing apparatus is an anticipated trajectory of at least one object, wherein the one or more target cameras are those cameras in the set of one or more cameras whose field of view is traversed by the anticipated trajectory.

In accordance with any of the preceding aspects, the processer is further caused to: computing a scheduled time at which to change the resource consumption mode for each of the one or more target cameras.

In accordance with any of the preceding aspects, changing the resource consumption mode of operation of the one or more target cameras comprises sending a command to the each of the one or more target cameras to change the resource consumption mode of operation at the scheduled time.

In accordance with any of the preceding aspects, the method further comprises: monitoring images or video or audio generated by a given one of the one or more of target cameras to determine if a condition is met and sending a command to the given one of the one or more target cameras to change the resource consumption mode of operation from the high resource consumption mode of operation to the low resource consumption mode of operation if the condition is met.

In accordance with any of the preceding aspects, the condition comprises the object no longer being in the field of view of the given one of the one or more target cameras.

According to a third example aspect, there is provided a computing apparatus communicatively coupled to a set of one or more cameras. The computing apparatus comprises: a processor; and memory including program code that, when executed by the processor, causes the processor to: monitor a resource consumption mode of operation of each of the cameras; and change the resource consumption mode of operation of one or more target cameras in the set of one or more cameras from a first resource consumption mode of operation to a second resource consumption mode of operation, the target cameras being selected based on an event characteristic detected by the computing apparatus, the first resource consumption mode of operation being a low resource consumption mode of operation and the second resource consumption mode of operation being a high resource consumption mode of operation.

In accordance with any of the preceding aspects, the one or more target cameras include at least one of an on-grid camera or an off-grid camera.

In accordance with any of the preceding aspects, the low resource consumption mode of operation is a low data consumption mode of operation and the high resource consumption mode of operation is a high data consumption mode of operation.

In accordance with any of the preceding aspects, when a given one of the one or more target cameras is in the high data consumption mode, the given one of the one or more target cameras consumes more wireless data than in low data consumption mode.

In accordance with any of the preceding aspects, the network interface of the given one of the one or more target cameras is operable to transmit to the computing apparatus at least one of (i) images generated by the given one of the one or more target; (ii) videos generated by the given one of the one or more target; or (iii) audio generated by the given one of the one or more target, in accordance with at least one data consumption parameter that affects wireless data utilization by the given one of the one or more target cameras.

In accordance with any of the preceding aspects, the at least one data consumption parameter comprises at least one of a data transmission setting indicative of whether real-time data transmission to the computing apparatus is enabled, a data consumption setting indicative of whether wireless data consumption is enabled, a threshold limit for an amount of data consumable over a given time period, bandwidth, transmission duty cycle, modulation scheme, data rate and latency.

In accordance with any of the preceding aspects, changing the resource consumption mode of operation from a low data consumption mode of operation to a high data consumption mode of operation comprises at least one of (i) decreasing a latency used by the network interface to transmit the generated images or audio to the computing apparatus (ii) enabling real-time data transmission to the computing apparatus or wireless data consumption by the network interface to transmit the generated images or videos or audio to the computing apparatus (iii) increasing a threshold limit for an amount of data consumed over a given time period, a bandwidth, a transmission duty cycle and/or a data rate used by the network interface to transmit the generated images or videos or audio to the computing apparatus; or (iv) changing a modulation scheme used by the network interface to transmit the generated images or videos or audio to the computing apparatus.

In accordance with any of the preceding aspects, the one or more target cameras are off-grid cameras.

In accordance with any of the preceding aspects, each off-grid camera includes a replenishable power supply.

In accordance with any of the preceding aspects, the replenishable power supply comprises an off-grid power supply.

In accordance with any of the preceding aspects, the low resource consumption mode of operation is a low power consumption mode of operation and the high resource consumption mode of operation is a high power consumption mode of operation.

In accordance with any of the preceding aspects, when a given one of the one or more target cameras is in the high power consumption mode of operation, the given one of the one or more target cameras consumes more power from the off-grid power supply than during the low power consumption mode of operation.

In accordance with any of the preceding aspects, when a given one of the one or more target cameras is in the lower power consumption mode of operation, the given one of the one or more target cameras is configured to capture still images; and when the given one of the one or more target cameras is in the high power consumption mode of operation, the given one of the one or more target cameras is configured to capture video.

In accordance with any of the preceding aspects, the AV generation system of the given one of the one or more target cameras is operable to generate at least one of images or videos or audio in accordance with at least one power consumption parameter that affects power utilization by the given one of the one or more target cameras.

In accordance with any of the preceding aspects, the at least one power consumption parameter comprises at least one of an image capture activation setting indicative of whether image or video capture is enabled, an audio capture activation setting indicative of whether audio capture is enabled, frame rate, image resolution, number of images captured over a given time period, activation of flash, a brightness of flash, a sampling rate, a detection rate, a compression ratio, and a threshold limit of acceptable false positive detections.

In accordance with any of the preceding aspects, changing from a low power consumption mode of operation to a high power consumption mode of operation comprises at least one of (i) enabling image capture, enabling video capture, enabling audio capture; (ii) increasing a frame rate, an image resolution, a number of images captured over the given time period, a brightness of flash, an activation of flash, and/or a sampling rate used by the AV generation system to generate images or videos or audio; (iii) increasing a detection rate or the threshold limit of acceptable false positive detections used by the processing entity to process the generated images or the generated videos or the generated audio; or (iv) decreasing a data compression ratio used by the AV generation system to generate images or videos or audio.

In accordance with any of the preceding aspects, the processing entity of a given one of the one or more target cameras is configured for carrying out first-level processing of captured images or videos or audio to create a result, wherein when the given one of the one or more target cameras is in the high power consumption mode of operation, the processing entity is configured for performing second-level processing on the result of the first-level processing and for sending a result of the second-level processing to the computing apparatus via the wireless network interface, and wherein when the given one of the one or more target cameras is in the low power consumption mode of operation, the processing entity is configured for sending the result of the first-level processing to the computing apparatus via the wireless network interface without performing the second-level processing on the result of the first-level processing.

In accordance with any of the preceding aspects, the event characteristic is detected by the computing apparatus based on at least one of: (i) responding to contents of images or videos or audio captured by a given one of the cameras in the set of one or more cameras; (ii) responding to a result received from a given one of the set of one or more cameras, the result created by the given one of the cameras in the set of one or more cameras further to the processing entity of the given one of the cameras in the set of one or more cameras carrying out processing of captured images or captured video or captured audio; or (iii) responding to a backend input received by the computing apparatus.

In accordance with any of the preceding aspects, the result comprises a license plate detection, an object detection or a gunshot detection.

In accordance with any of the preceding aspects, the backend input comprises an input indicative of a computer-aided dispatch call, a call received from an emergency service or an AMBER (America's Missing: Broadcast Emergency Response) Alert.

In accordance with any of the preceding aspects, the event characteristic detected by the computing apparatus includes one of a location, a location of an object, a direction of travel of an object and a speed of travel of an object.

In accordance with any of the preceding aspects, the target cameras are those cameras of the set of one or more cameras whose field of view or whose pickup range is in within a threshold distance of the location or of the object.

In accordance with any of the preceding aspects, changing the resource consumption mode of operation of a given one of the one or more target cameras is carried out irrespective of a battery charge level of the given one of the one or more target cameras.

In accordance with any of the preceding aspects, changing the resource consumption mode of operation of a given one of the one or more target cameras is carried out irrespective of a data consumption level of the given one of the one or more target cameras.

In accordance with any of the preceding aspects, the processer is further caused to: for a given one of the one or more target cameras, change the resource consumption mode of operation from the high consumption mode of operation to the low consumption mode of operation based on a relinquish condition determined to having been met by the computing apparatus and control at least one resource consumption parameter of the given one of the one or more target cameras to change the resource consumption mode of operation from the high consumption mode of operation to the low consumption mode of operation.

In accordance with any of the preceding aspects, the relinquish condition having been met comprises a given amount of time having elapsed.

In accordance with any of the preceding aspects, the processer is further caused to: receive an input from a given one of the one or more target cameras indicative of a change from the high consumption mode of operation to the low consumption mode operation further to a determination by the given one of the one or more target cameras that a relinquish condition has been met and updating a resource consumption mode database stored in a memory of the computing apparatus.

In accordance with any of the preceding aspects, the event characteristic detected by the computing apparatus is an anticipated trajectory of at least one object, wherein the one or more target cameras are those cameras in the set of one or more cameras whose field of view is traversed by the anticipated trajectory.

In accordance with any of the preceding aspects, the processer is further caused to: compute a scheduled time at which to change the resource consumption mode for each of the one or more target cameras.

In accordance with any of the preceding aspects, changing the resource consumption mode of operation of the one or more target cameras comprises sending a command to the each of the one or more target cameras to change the resource consumption mode of operation at the scheduled time.

In accordance with any of the preceding aspects, the processer is further caused to: monitor images or video or audio generated by a given one of the one or more of target cameras to determine if a condition is met and sending a command to the given one of the one or more target cameras to change the resource consumption mode of operation from the high resource consumption mode of operation to the low resource consumption mode of operation if the condition is met.

In accordance with any of the preceding aspects, the condition comprises the object no longer being in the field of view of the given one of the one or more target cameras.

According to a fourth example aspect, there is provided a method of operating an instructing camera. The instructing camera comprises an instructing computing apparatus communicatively coupled to a set of one or more cameras, the method comprising: monitoring a resource consumption mode of operation each of the cameras in the set of one or more cameras; and changing the resource consumption mode of operation of a target camera in the set of one or more cameras from a first resource consumption mode of operation to a second resource consumption mode of operation, the target camera being selected based on an event characteristic detected by the instructing computing apparatus of the instructing camera, the first resource consumption mode of operation being a low resource consumption mode of operation and the second resource consumption mode of operation being a high resource consumption mode of operation.

In accordance with any of the preceding aspects, each of the cameras in the set of one or more cameras comprises: an audiovisual (AV) generation system configured to generate at least one of images or videos or audio, the AV generation system comprising at least one of an image capture device configured to capture images or an audio capture device configured to capture audio, the AV generation system further comprising a processing entity configured to process at least one of the captured images or the captured video or the captured audio; and a network interface operable to transmit to a second computing apparatus at least one of the images or videos or the audio generated by cameras in the set of one or more cameras.

In accordance with any of the preceding aspects, the target camera is an on-grid camera or an off-grid camera.

In accordance with any of the preceding aspects, the low resource consumption mode of operation is a low data consumption mode of operation and the high resource consumption mode of operation is a high data consumption mode of operation.

In accordance with any of the preceding aspects, when the target camera is in the high data consumption mode, the target camera consumes more wireless data than in low data consumption mode.

In accordance with any of the preceding aspects, the network interface of the target camera is operable to transmit to the second computing apparatus at least one of (i) images generated by the target camera; (ii) videos generated by the target camera; or (iii) audio generated by the target camera, in accordance with at least one data consumption parameter that affects wireless data utilization by the target camera.

In accordance with any of the preceding aspects, the at least one data consumption parameter comprises at least one of a data transmission setting indicative of whether real-time data transmission to the second computing apparatus is enabled, a data consumption setting indicative of whether wireless data consumption is enabled, a threshold limit for an amount of data consumable over a given time period, bandwidth, transmission duty cycle, modulation scheme, data rate and latency.

In accordance with any of the preceding aspects, changing the resource consumption mode of operation from a low data consumption mode of operation to a high data consumption mode of operation comprises at least one of (i) decreasing a latency used by the network interface to transmit the generated images or audio to the second computing apparatus (ii) enabling real-time data transmission to the second computing apparatus or wireless data consumption by the network interface to transmit the generated images or videos or audio to the second computing apparatus (iii) increasing a threshold limit for an amount of data consumed over a given time period, a bandwidth, a transmission duty cycle and/or a data rate used by the network interface to transmit the generated images or videos or audio to the second computing apparatus; or (iv) changing a modulation scheme used by the network interface to transmit the generated images or videos or audio to the second computing apparatus.

In accordance with any of the preceding aspects, the target camera is an off-grid cameras.

In accordance with any of the preceding aspects, the off-grid camera includes a replenishable power supply.

In accordance with any of the preceding aspects, the replenishable power supply comprises an off-grid power supply.

In accordance with any of the preceding aspects, the low resource consumption mode of operation is a low power consumption mode of operation and the high resource consumption mode of operation is a high power consumption mode of operation.

In accordance with any of the preceding aspects, when the target camera is in the high power consumption mode of operation, the target camera consumes more power from the off-grid power supply than during the low power consumption mode of operation.

In accordance with any of the preceding aspects, the target camera is in the lower power consumption mode of operation, the target camera is configured to capture still images; and when the given one of the target camera is in the high power consumption mode of operation, the target camera is configured to capture video.

In accordance with any of the preceding aspects, the AV generation system of the target camera is operable to generate at least one of images or videos or audio in accordance with at least one power consumption parameter that affects power utilization by the given one of the target camera.

In accordance with any of the preceding aspects, the at least one power consumption parameter comprises at least one of an image capture activation setting indicative of whether image or video capture is enabled, an audio capture activation setting indicative of whether audio capture is enabled, frame rate, image resolution, number of images captured over a given time period, activation of flash, a brightness of flash, a sampling rate, a detection rate, a compression ratio, and a threshold limit of acceptable false positive detections.

In accordance with any of the preceding aspects, changing from a low power consumption mode of operation to a high power consumption mode of operation comprises at least one of (i) enabling image capture, enabling video capture, enabling audio capture; (ii) increasing a frame rate, an image resolution, a number of images captured over the given time period, a brightness of flash, an activation of flash and/or a sampling rate used by the AV generation system to generate images or videos or audio; (iii) increasing a detection rate or the threshold limit of acceptable false positive detections used by the processing entity to process the generated images or the generated videos or the generated audio; or (iv) decreasing a data compression ratio used by the AV generation system to generate images or videos or audio.

In accordance with any of the preceding aspects, the processing entity of the target camera is configured for carrying out first-level processing of captured images or videos or audio to create a result, wherein when the target camera is in the high power consumption mode of operation, the processing entity is configured for performing second-level processing on the result of the first-level processing and for sending a result of the second-level processing to the second computing apparatus via the wireless network interface, and wherein when the given one of the target camera is in the low power consumption mode of operation, the processing entity is configured for sending the result of the first-level processing to the computing apparatus via the wireless network interface without performing the second-level processing on the result of the first-level processing.

In accordance with any of the preceding aspects, the event characteristic is detected by the instructing computing apparatus based on at least one of: (i) contents of images or videos or audio captured by the instructing camera; (ii) responding to contents of images or videos or audio captured by a given one of the cameras in the set of one or more cameras; (iii) responding to a result received from a given one of the set of one or more cameras, the result created by the given one of the cameras in the set of one or more cameras further to the processing entity of the given one of the cameras in the set of one or more cameras carrying out processing of captured images or captured video or captured audio; or (iv) responding to a backend input received by the second computing apparatus.

In accordance with any of the preceding aspects, the result comprises a license plate detection, an object detection or a gunshot detection.

In accordance with any of the preceding aspects, the backend input comprises an input indicative of a computer-aided dispatch call, a call received from an emergency service or an AMBER (America's Missing: Broadcast Emergency Response) Alert.

In accordance with any of the preceding aspects, the event characteristic detected by the instructing computing apparatus includes one of a location, a location of an object, a direction of travel of an object and a speed of travel of an object.

In accordance with any of the preceding aspects, the target cameras is a camera whose field of view or whose pickup range is in within a threshold distance of the location or of the object.

In accordance with any of the preceding aspects, changing the resource consumption mode of operation of the target camera is carried out irrespective of a battery charge level of the target camera.

In accordance with any of the preceding aspects, changing the resource consumption mode of operation of the target camera is carried out irrespective of a data consumption level of the target camera.

In accordance with any of the preceding aspects, the method further comprises, changing the resource consumption mode of operation from the high consumption mode of operation to the low consumption mode of operation based on a relinquish condition determined to having been met by the instructing computing apparatus and controlling at least one resource consumption parameter of the target camera to change the resource consumption mode of operation from the high consumption mode of operation to the low consumption mode of operation.

In accordance with any of the preceding aspects, the relinquish condition having been met comprises a given amount of time having elapsed.

In accordance with any of the preceding aspects, the method further comprises receiving an input from the target camera indicative of a change from the high consumption mode of operation to the low consumption mode operation further to a determination by the target camera that a relinquish condition has been met and updating a resource consumption mode database stored in a memory of the instructing computing apparatus.

In accordance with any of the preceding aspects, the event characteristic detected by the instructing computing apparatus is an anticipated trajectory of at least one object, wherein the target camera is a camera in the set of one or more cameras whose field of view is traversed by the anticipated trajectory.

In accordance with any of the preceding aspects, the method further comprises computing a scheduled time at which to change the resource consumption mode for the target camera.

In accordance with any of the preceding aspects, changing the resource consumption mode of operation of the target camera comprises sending a command to the target camera to change the resource consumption mode of operation at the scheduled time.

In accordance with any of the preceding aspects, the method further comprises monitoring images or video or audio generated by a given one of the cameras in the set of cameras or the target camera to determine if a condition is met and sending a command to the target camera to change the resource consumption mode of operation from the high resource consumption mode of operation to the low resource consumption mode of operation if the condition is met.

In accordance with any of the preceding aspects, the condition comprises the object no longer being in the field of view of the target camera.

In accordance with any of the preceding aspects, the target camera is a plurality of target cameras.

According to a fifth example aspect, there is provided non-transitory computer-readable medium storing instructions which, when read and executed by a processor of an instructing computing apparatus of an instructing camera communicatively coupled to a set of one or more cameras, cause the processor to carry out a method that comprises: monitoring a resource consumption mode of operation of each of the cameras in the set of one or more cameras; and changing the resource consumption mode of operation of a target camera in the set of one or more cameras from a first resource consumption mode of operation to a second resource consumption mode of operation, the target camera being selected based on an event characteristic detected by the instructing computing apparatus of the instructing camera, the first resource consumption mode of operation being a low resource consumption mode of operation and the second resource consumption mode of operation being a high resource consumption mode of operation.

In accordance with any of the preceding aspects, the target camera is an on-grid camera or an off-grid camera.

In accordance with any of the preceding aspects, the low resource consumption mode of operation is a low data consumption mode of operation and the high resource consumption mode of operation is a high data consumption mode of operation.

In accordance with any of the preceding aspects, when the target camera is in the high data consumption mode, the target camera consumes more wireless data than in low data consumption mode.

In accordance with any of the preceding aspects, the network interface of the target camera is operable to transmit to the second computing apparatus at least one of (i) images generated by the target camera; (ii) videos generated by the target camera; or (iii) audio generated by the target camera, in accordance with at least one data consumption parameter that affects wireless data utilization by the target camera.

In accordance with any of the preceding aspects, the at least one data consumption parameter comprises at least one of a data transmission setting indicative of whether real-time data transmission to the second computing apparatus is enabled, a data consumption setting indicative of whether wireless data consumption is enabled, a threshold limit for an amount of data consumable over a given time period, bandwidth, transmission duty cycle, modulation scheme, data rate and latency.

In accordance with any of the preceding aspects, changing the resource consumption mode of operation from a low data consumption mode of operation to a high data consumption mode of operation comprises at least one of (i) decreasing a latency used by the network interface to transmit the generated images or audio to the second computing apparatus (ii) enabling real-time data transmission to the second computing apparatus or wireless data consumption by the network interface to transmit the generated images or videos or audio to the second computing apparatus (iii) increasing a threshold limit for an amount of data consumed over a given time period, a bandwidth, a transmission duty cycle and/or a data rate used by the network interface to transmit the generated images or videos or audio to the second computing apparatus; or (iv) changing a modulation scheme used by the network interface to transmit the generated images or videos or audio to the second computing apparatus.

In accordance with any of the preceding aspects, the target camera is an off-grid cameras.

In accordance with any of the preceding aspects, the off-grid camera includes a replenishable power supply.

In accordance with any of the preceding aspects, the replenishable power supply comprises an off-grid power supply.

In accordance with any of the preceding aspects, the low resource consumption mode of operation is a low power consumption mode of operation and the high resource consumption mode of operation is a high power consumption mode of operation.

In accordance with any of the preceding aspects, when the target camera is in the high power consumption mode of operation, the target camera consumes more power from the off-grid power supply than during the low power consumption mode of operation.

In accordance with any of the preceding aspects, the target camera is in the lower power consumption mode of operation, the target camera is configured to capture still images; and when the given one of the target camera is in the high power consumption mode of operation, the target camera is configured to capture video.

In accordance with any of the preceding aspects, the AV generation system of the target camera is operable to generate at least one of images or videos or audio in accordance with at least one power consumption parameter that affects power utilization by the given one of the target camera.

In accordance with any of the preceding aspects, the at least one power consumption parameter comprises at least one of an image capture activation setting indicative of whether image or video capture is enabled, an audio capture activation setting indicative of whether audio capture is enabled, frame rate, image resolution, number of images captured over a given time period, activation of flash, a brightness of flash, a sampling rate, a detection rate, a compression ratio, and a threshold limit of acceptable false positive detections.

In accordance with any of the preceding aspects, changing from a low power consumption mode of operation to a high power consumption mode of operation comprises at least one of (i) enabling image capture, enabling video capture, enabling audio capture; (ii) increasing a frame rate, an image resolution, a number of images captured over the given time period, a brightness of flash, an activation of flash and/or a sampling rate used by the AV generation system to generate images or videos or audio; (iii) increasing a detection rate or the threshold limit of acceptable false positive detections used by the processing entity to process the generated images or the generated videos or the generated audio; or (iv) decreasing a data compression ratio used by the AV generation system to generate images or videos or audio.

In accordance with any of the preceding aspects, the processing entity of the target camera is configured for carrying out first-level processing of captured images or videos or audio to create a result, wherein when the target camera is in the high power consumption mode of operation, the processing entity is configured for performing second-level processing on the result of the first-level processing and for sending a result of the second-level processing to the second computing apparatus via the wireless network interface, and wherein when the given one of the target camera is in the low power consumption mode of operation, the processing entity is configured for sending the result of the first-level processing to the computing apparatus via the wireless network interface without performing the second-level processing on the result of the first-level processing.

In accordance with any of the preceding aspects, the event characteristic is detected by the instructing computing apparatus based on at least one of: (i) contents of images or videos or audio captured by the instructing camera; (ii) responding to contents of images or videos or audio captured by a given one of the cameras in the set of one or more cameras; (iii) responding to a result received from a given one of the set of one or more cameras, the result created by the given one of the cameras in the set of one or more cameras further to the processing entity of the given one of the cameras in the set of one or more cameras carrying out processing of captured images or captured video or captured audio; or (iv) responding to a backend input received by the second computing apparatus.

In accordance with any of the preceding aspects, the result comprises a license plate detection, an object detection or a gunshot detection.

In accordance with any of the preceding aspects, the backend input comprises an input indicative of a computer-aided dispatch call, a call received from an emergency service or an AMBER (America's Missing: Broadcast Emergency Response) Alert.

In accordance with any of the preceding aspects, the event characteristic detected by the instructing computing apparatus includes one of a location, a location of an object, a direction of travel of an object and a speed of travel of an object.

In accordance with any of the preceding aspects, the target cameras is a camera whose field of view or whose pickup range is in within a threshold distance of the location or of the object.

In accordance with any of the preceding aspects, changing the resource consumption mode of operation of the target camera is carried out irrespective of a battery charge level of the target camera.

In accordance with any of the preceding aspects, changing the resource consumption mode of operation of the target camera is carried out irrespective of a data consumption level of the target camera.

In accordance with any of the preceding aspects, the method further comprises, changing the resource consumption mode of operation from the high consumption mode of operation to the low consumption mode of operation based on a relinquish condition determined to having been met by the instructing computing apparatus and controlling at least one resource consumption parameter of the target camera to change the resource consumption mode of operation from the high consumption mode of operation to the low consumption mode of operation.

In accordance with any of the preceding aspects, the relinquish condition having been met comprises a given amount of time having elapsed.

In accordance with any of the preceding aspects, the method further comprises receiving an input from the target camera indicative of a change from the high consumption mode of operation to the low consumption mode operation further to a determination by the target camera that a relinquish condition has been met and updating a resource consumption mode database stored in a memory of the instructing computing apparatus.

In accordance with any of the preceding aspects, the event characteristic detected by the instructing computing apparatus is an anticipated trajectory of at least one object, wherein the target camera is a camera in the set of one or more cameras whose field of view is traversed by the anticipated trajectory.

In accordance with any of the preceding aspects, the method further comprises computing a scheduled time at which to change the resource consumption mode for the target camera.

In accordance with any of the preceding aspects, changing the resource consumption mode of operation of the target camera comprises sending a command to the target camera to change the resource consumption mode of operation at the scheduled time.

In accordance with any of the preceding aspects, the method further comprises monitoring images or video or audio generated by a given one of the cameras in the set of cameras or the target camera to determine if a condition is met and sending a command to the target camera to change the resource consumption mode of operation from the high resource consumption mode of operation to the low resource consumption mode of operation if the condition is met.

In accordance with any of the preceding aspects, the condition comprises the object no longer being in the field of view of the target camera.

In accordance with any of the preceding aspects, the target camera is a plurality of target cameras.

According to a sixth example aspect, there is provided a system comprising: a set of one or more cameras; and an instructing camera comprising an instructing computing apparatus communicatively coupled to the set of one or more cameras. The instructing computing apparatus comprises: a processor; and memory including program code that, when executed by the processor, causes the processor to: monitor a resource consumption mode of operation of each of the cameras in the set of one or more cameras; and change the resource consumption mode of operation of a target camera in the set of one or more cameras from a first resource consumption mode of operation to a second resource consumption mode of operation, the target camera being selected based on an event characteristic detected by the instructing computing apparatus of the commanding camera, the first resource consumption mode of operation being a low resource consumption mode of operation and the second resource consumption mode of operation being a high resource consumption mode of operation.

In accordance with any of the preceding aspects, the target camera is an on-grid camera or an off-grid camera.

In accordance with any of the preceding aspects, the low resource consumption mode of operation is a low data consumption mode of operation and the high resource consumption mode of operation is a high data consumption mode of operation.

In accordance with any of the preceding aspects, when the target camera is in the high data consumption mode, the target camera consumes more wireless data than in low data consumption mode.

In accordance with any of the preceding aspects, the network interface of the target camera is operable to transmit to the second computing apparatus at least one of (i) images generated by the target camera; (ii) videos generated by the target camera; or (iii) audio generated by the target camera, in accordance with at least one data consumption parameter that affects wireless data utilization by the target camera.

In accordance with any of the preceding aspects, the at least one data consumption parameter comprises at least one of a data transmission setting indicative of whether real-time data transmission to the second computing apparatus is enabled, a data consumption setting indicative of whether wireless data consumption is enabled, a threshold limit for an amount of data consumable over a given time period, bandwidth, transmission duty cycle, modulation scheme, data rate and latency.

In accordance with any of the preceding aspects, changing the resource consumption mode of operation from a low data consumption mode of operation to a high data consumption mode of operation comprises at least one of (i) decreasing a latency used by the network interface to transmit the generated images or audio to the second computing apparatus (ii) enabling real-time data transmission to the second computing apparatus or wireless data consumption by the network interface to transmit the generated images or videos or audio to the second computing apparatus (iii) increasing a threshold limit for an amount of data consumed over a given time period, a bandwidth, a transmission duty cycle and/or a data rate used by the network interface to transmit the generated images or videos or audio to the second computing apparatus; or (iv) changing a modulation scheme used by the network interface to transmit the generated images or videos or audio to the second computing apparatus.

In accordance with any of the preceding aspects, the target camera is an off-grid cameras.

In accordance with any of the preceding aspects, the off-grid camera includes a replenishable power supply.

In accordance with any of the preceding aspects, the replenishable power supply comprises an off-grid power supply.

In accordance with any of the preceding aspects, the low resource consumption mode of operation is a low power consumption mode of operation and the high resource consumption mode of operation is a high power consumption mode of operation.

In accordance with any of the preceding aspects, when the target camera is in the high power consumption mode of operation, the target camera consumes more power from the off-grid power supply than during the low power consumption mode of operation.

In accordance with any of the preceding aspects, the target camera is in the lower power consumption mode of operation, the target camera is configured to capture still images; and when the given one of the target camera is in the high power consumption mode of operation, the target camera is configured to capture video.

In accordance with any of the preceding aspects, the AV generation system of the target camera is operable to generate at least one of images or videos or audio in accordance with at least one power consumption parameter that affects power utilization by the given one of the target camera.

In accordance with any of the preceding aspects, the at least one power consumption parameter comprises at least one of an image capture activation setting indicative of whether image or video capture is enabled, an audio capture activation setting indicative of whether audio capture is enabled, frame rate, image resolution, number of images captured over a given time period, activation of flash, a brightness of flash, a sampling rate, a detection rate, a compression ratio, and a threshold limit of acceptable false positive detections.

In accordance with any of the preceding aspects, changing from a low power consumption mode of operation to a high power consumption mode of operation comprises at least one of (i) enabling image capture, enabling video capture, enabling audio capture; (ii) increasing a frame rate, an image resolution, a number of images captured over the given time period, a brightness of flash, an activation of flash and/or a sampling rate used by the AV generation system to generate images or videos or audio; (iii) increasing a detection rate or the threshold limit of acceptable false positive detections used by the processing entity to process the generated images or the generated videos or the generated audio; or (iv) decreasing a data compression ratio used by the AV generation system to generate images or videos or audio.

In accordance with any of the preceding aspects, the processing entity of the target camera is configured for carrying out first-level processing of captured images or videos or audio to create a result, wherein when the target camera is in the high power consumption mode of operation, the processing entity is configured for performing second-level processing on the result of the first-level processing and for sending a result of the second-level processing to the second computing apparatus via the wireless network interface, and wherein when the given one of the target camera is in the low power consumption mode of operation, the processing entity is configured for sending the result of the first-level processing to the computing apparatus via the wireless network interface without performing the second-level processing on the result of the first-level processing.

In accordance with any of the preceding aspects, the event characteristic is detected by the instructing computing apparatus based on at least one of: (i) contents of images or videos or audio captured by the instructing camera; (ii) responding to contents of images or videos or audio captured by a given one of the cameras in the set of one or more cameras; (iii) responding to a result received from a given one of the set of one or more cameras, the result created by the given one of the cameras in the set of one or more cameras further to the processing entity of the given one of the cameras in the set of one or more cameras carrying out processing of captured images or captured video or captured audio; or (iv) responding to a backend input received by the second computing apparatus.

In accordance with any of the preceding aspects, the result comprises a license plate detection, an object detection or a gunshot detection.

In accordance with any of the preceding aspects, the backend input comprises an input indicative of a computer-aided dispatch call, a call received from an emergency service or an AMBER (America's Missing: Broadcast Emergency Response) Alert.

In accordance with any of the preceding aspects, the event characteristic detected by the instructing computing apparatus includes one of a location, a location of an object, a direction of travel of an object and a speed of travel of an object.

In accordance with any of the preceding aspects, the target cameras is a camera whose field of view or whose pickup range is in within a threshold distance of the location or of the object.

In accordance with any of the preceding aspects, changing the resource consumption mode of operation of the target camera is carried out irrespective of a battery charge level of the target camera.

In accordance with any of the preceding aspects, changing the resource consumption mode of operation of the target camera is carried out irrespective of a data consumption level of the target camera.

In accordance with any of the preceding aspects, the processor is further caused to: change the resource consumption mode of operation from the high consumption mode of operation to the low consumption mode of operation based on a relinquish condition determined to having been met by the instructing computing apparatus and control at least one resource consumption parameter of the target camera to change the resource consumption mode of operation from the high consumption mode of operation to the low consumption mode of operation.

In accordance with any of the preceding aspects, the relinquish condition having been met comprises a given amount of time having elapsed.

In accordance with any of the preceding aspects, the processor is further caused to: receive an input from the target camera indicative of a change from the high consumption mode of operation to the low consumption mode operation further to a determination by the target camera that a relinquish condition has been met and update a resource consumption mode database stored in a memory of the instructing computing apparatus.

In accordance with any of the preceding aspects, the event characteristic detected by the instructing computing apparatus is an anticipated trajectory of at least one object, wherein the target camera is a camera in the set of one or more cameras whose field of view is traversed by the anticipated trajectory.

In accordance with any of the preceding aspects, the processor is further caused to: compute a scheduled time at which to change the resource consumption mode for the target camera.

In accordance with any of the preceding aspects, changing the resource consumption mode of operation of the target camera comprises sending a command to the target camera to change the resource consumption mode of operation at the scheduled time.

In accordance with any of the preceding aspects, the processor is further caused to: monitor images or video or audio generated by a given one of the cameras in the set of cameras or the target camera to determine if a condition is met and send a command to the target camera to change the resource consumption mode of operation from the high resource consumption mode of operation to the low resource consumption mode of operation if the condition is met.

In accordance with any of the preceding aspects, the condition comprises the object no longer being in the field of view of the target camera.

In accordance with any of the preceding aspects, the target camera is a plurality of target cameras.

### BRIEF DESCRIPTION OF THE DRAWINGS

Reference will now be made, by way of example, to the accompanying drawings which show example embodiments of the present application, and in which:

FIG. 1 is a schematic diagram of an example system in accordance with a non-limiting embodiment, involving a plurality of cameras and a server;

FIGS. 2A and 2B are block diagrams illustrating example components of an off-grid camera in the system of FIG. 1;

FIG. 2C is a block diagram illustrating example components of an on-grid camera in the system of FIG. 1;

FIG. 2D is a block diagram illustrating example components of an audiovisual generation system of a camera of FIG. 1;

FIG. 2E is a block diagram illustrating examples components of the server in the system of FIG. 1;

FIG. 3 is a functional representation of the server, including a camera control module of a camera, a monitoring module, a parameter database, a policy database and a camera interface module, in accordance with a non-limiting embodiment;

FIG. 4 is a flowchart of a non-limiting embodiment of a camera control process that may be carried out by the camera control module;

FIG. 5A is a flowchart of a non-limiting embodiment of a dynamic mode change method that may be carried out by the camera control module;

FIGS. 5B and 5C are a conceptual representation of steps in the camera control process of FIG. 4;

FIG. 6A is conceptual diagram showing occurrence of an example event;

FIGS. 6B to 6D are conceptual representation of steps in a camera control process taking into consideration an anticipated trajectory of an object, in accordance with a non-limiting embodiment;

FIGS. 6E to 6J are conceptual representation of steps in a camera control process taking into consideration a camera control policy, in accordance with a non-limiting embodiment;

FIGS. 7A and 7B are conceptual diagrams illustrating where different levels of processing can be carried out, depending on an operation mode of the camera, in accordance with a non-limiting embodiment;

FIG. 8 is a flowchart of a non-limiting embodiment of a camera control process that may be carried out by the camera control module;

FIG. 9 is a flowchart of a non-limiting embodiment of a command dispatch process that may be carried out by the camera control module of the camera;

FIG. 10 is a functional representation of an instructing camera, including a camera control module of a camera, a monitoring module, a parameter database, a policy database and a camera interface module, in accordance with a non-limiting embodiment; and

FIG. 11 is a schematic diagram of an example system in accordance with a non-limiting embodiment, involving a plurality of cameras.

In the drawings, embodiments are illustrated by way of example. It is to be expressly understood that the description and drawings are only for purposes of illustrating certain embodiments and are an aid for understanding. They are not intended to be a definition of the limits of the invention.

### DETAILED DESCRIPTION

### System

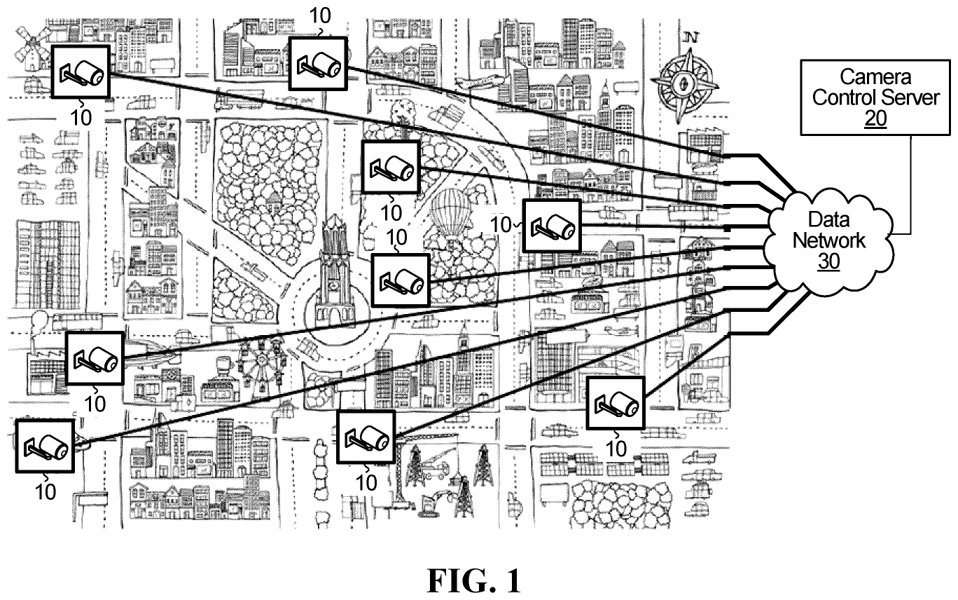

FIG. 1 shows a system including a plurality of cameras 10 connected via a data network 30 to a camera control server 20. The data network 30 may have an infrastructure that supports a data communication protocol, such as a datagram exchange protocol (e.g., UDP or TCP/IP). In an example embodiment, the data network 30 could include or traverse the Internet.

Each camera 10 is an audiovisual device capable of capturing images, videos and/or audio 2081 and communicating with the server 20. For example, the camera 10 could be a surveillance audiovisual device such as a security camera or any other suitably enabled device that has an ability to capture images, videos and/or audio 2081 of events occurring around a geographical area of the camera 10. The camera 10 may be a still image camera or a video camera. It is to be understood that, as used herein, “images” may refer to frames of video and that “video” may include audio.

### Camera 10

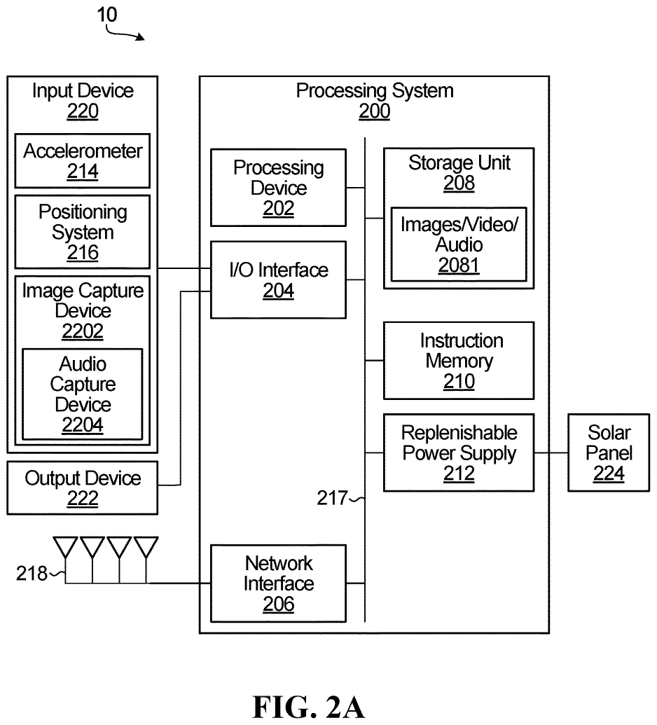

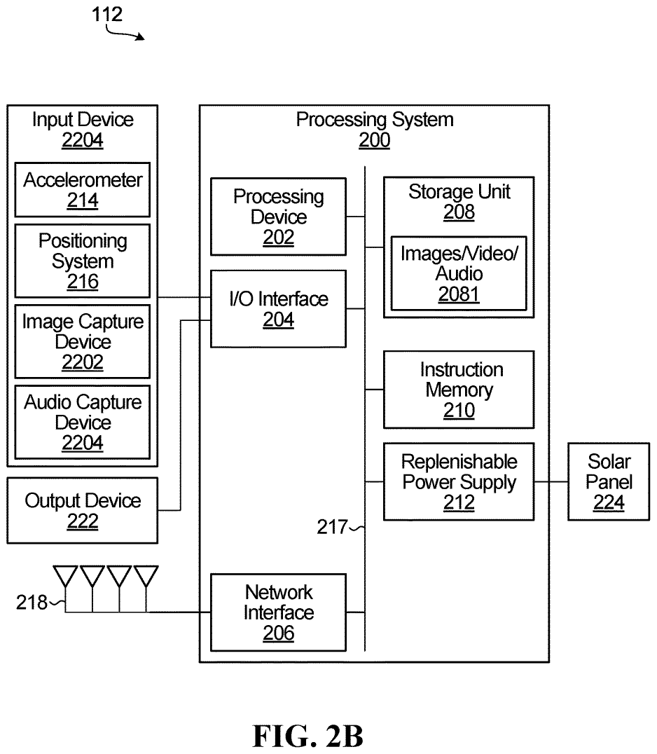

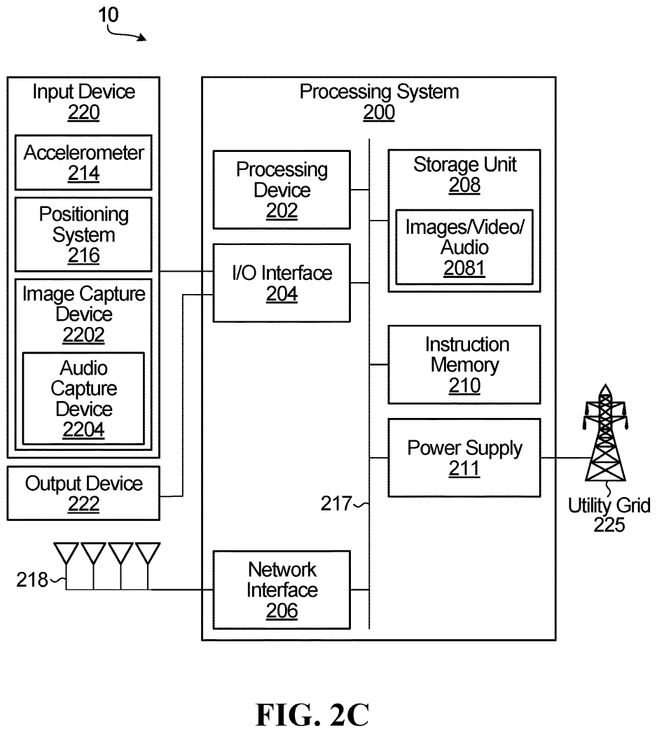

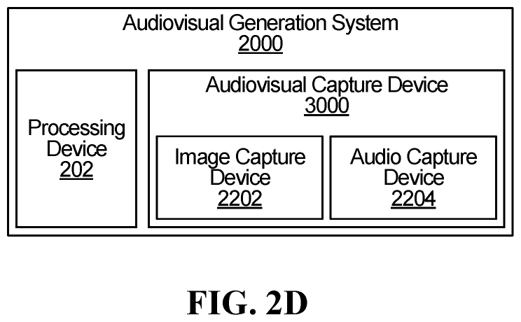

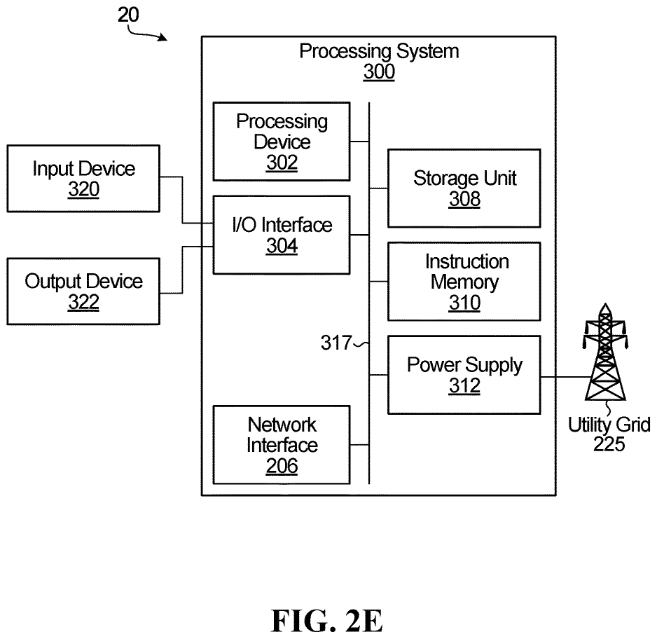

FIG. 2A is a block diagram of example components of the camera 10. Although FIG. 2A may show a single instance of each component, there may be multiple instances of each component in the camera 10.

The camera 10 comprises a suitably configured wireless transceiver 218 for exchanging at least data communications over a wireless link via a wireless access point. The wireless transceiver 218 could include one or more radio-frequency antennas. The wireless transceiver 218 could be configured for wireless communication such as cellular communication or Wi-Fi communication, depending on the type of wireless access point with which the camera 10 wishes to communicate. The wireless transceiver 218 may also comprise a wireless personal area network (WPAN) transceiver, such as a short-range wireless or Bluetooth® transceiver, for communicating with a computer (not shown) or other Bluetooth® enabled devices such a smartphone. The wireless transceiver 218 can also include a near field communication (NFC) transceiver. The wireless transceiver 218 can also include a long-range (LoRa) low power wireless transceiver for radio communication (e.g., in accordance with a LoRaWAN (Wide Area Network) communication protocol). The wireless transceiver 218 is connected to a processing system 200, specifically via a network interface 206 of the processing system 200.

The camera 10 also includes an input device 220. The input device 220 may comprise an image capture device 2202, such as a camera. The image capture device 2202 is configured to capture the images, videos and/or audio 2081 in accordance with specific audiovisual capture parameters (which include image capture parameters). In some examples, the audiovisual capture parameters may include at least one of frame rate, image resolution, number of images captured over a given time period, activation of flash and brightness of flash. It is to be understood that, in other cases, the activation of the flash may be controlled independently from the image capture device 2202 such that the audiovisual capture parameters do not include activation of flash.

The frame rate refers to a frequency at which consecutive images are captured. For example, a frame rate for the camera 10 may be 24 frames per second (fps). The image resolution refers to a size of an image that the camera 10 produces. The image resolution indicates image pixels of the produced image. More resolution can mean better quality. For example, if the camera 10 is a 2.0-megapixel camera, an image produced by the camera 10 may include 1600×1200 pixels. Thus, the image resolution of the camera 10 would be 1600×1200 pixels. The number of images captured over the given time period represents a total number of images captured during the given time period, which would correspond to the frame rate times the length of the given time period if the frame rate is constant, but otherwise is an independent variable if the frame rate is not constant. Activation of flash may include a status of a flash of the image capture device 2202 and/or a brightness of such flash. The status of the flash indicates whether the flash is turned on or off. The brightness of the flash represents a value of brightness of light that the flash generates, ranging from a low percentage value to a maximum value (100%).

The input device 220 may include an audio capture device 2204, such as a microphone, as shown in FIGS. 2A and 2B. The audio capture device 2204 is configured to capture audio in accordance with specific audiovisual capture parameters (which include audio capture parameters). In some examples, the audiovisual capture parameters may include a sampling rate.

As shown in FIG. 2A, the audio capture device 2204 may be integrated as part of the image capture device 2202 such that the image capture device 2202 captures images, videos and/or audio Alternatively, as shown in FIG. 2B, the audio capture device 2204 may be separate from the image capture device 2202.

In some cases, the camera 10 may be configured such that image capture is enabled and in other cases, the camera 10 is configured such that image capture is disabled. An audiovisual activation parameter of the camera 10 is indicative of whether image capture is enabled or disabled. For example, an “image capture enabled” status of the audiovisual activation parameter is indicative of the image capture device 2202 being configured such that capture of images and/or video (which may include audio) is enabled and a “image capture disabled” status of the audiovisual activation parameter is indicative of the image capture device 2202 being configured such that capture of images and/or video (which may include audio) is disabled.

In some cases, the camera 10 may be configured such that audio capture is enabled and in other cases, the camera 10 is configured such that audio capture is disabled. An audiovisual activation parameter of the camera 10 is indicative of whether audio capture is enabled or disabled. For example, an “audio capture enabled” status of the audiovisual activation parameter is indicative of the audio capture device 2204 (alone or as part of the image capture device 2202) being configured such that capture of audio is enabled and an “audio capture disabled” status of the audiovisual activation parameter is indicative of the audio capture device 2204 (alone or as part of the image capture device 2202) being configured such that capture of video (which may include audio) and/or audio is disabled.

In some cases, the camera 10 may be configured to capture images and/or video with audio and yet in other cases, the camera 10 may be configured to capture images and/or video without audio. Additionally, in some cases, the camera 10 may be configured to capture audio only (without images and/or video).

The input device 220 may include other components, including sensor systems such as an accelerometer system 214 and a positioning system 216. The accelerometer system 214 may be configured to detect movement or motion of the camera 10. The positioning system 216 may be configured to determine the position of the camera 10 in two-dimensional or three-dimensional space. The image capture device 2202, the accelerometer system 214 and the positioning system 216 are connected to the processing system 200, specifically via an I/O interface 204.

The processing system 200 may include a processing device 202, such as a central processing unit (CPU), a graphics processing unit (GPU), a tensor processing unit (TPU), a neural processing unit (NPU), an application-specific integrated circuit (ASIC), a field-programmable gate array (FPGA), a dedicated logic circuitry, or combinations thereof.

The processing system 200 may also include a storage unit 208, which may include a mass storage unit such as a solid state drive, a hard disk drive, a magnetic disk drive and/or an optical disk drive. In some examples, the storage unit 208 may store images, videos, and/or audio 2081 captured by the image capture device 2202 (and/or the audio capture device 2204.)

In some embodiments, the camera 10 may carry out audiovisual processing to process the captured images, videos, and/or audio 2081, for example including image detection such as motion detection and object detection such as license plate detection, facial recognition, and audio detection such as gunshot detection, voice detection, speech detection, environmental sound detection and so on. It is to be understood that “detection” may also involve “recognition” of the detected elements. It is also to be understood that image detection and audio detection may be carried out alone or in conjunction with one another. Audiovisual processing of the captured images, videos, and/or audio 2081 may be carried out in order to detect occurrence of an event and determine characteristics of the event, such as the event, direction and speed of movement (for instance, detectable using Doppler if no images are available).

The audiovisual processing may be carried out by the processing device 202 of the processing system 200. The camera 10 may be configured to process the images, videos, and/or audio 2081 in accordance with specific audiovisual processing parameters (which may include image processing parameters and audio processing parameters). In some examples, the audiovisual processing parameters may include an image detection rate which defines the rate at which frames of images are processed for detection (e.g., an image detector rate indicative of the rate at which images are passed through an image detector, which may in some cases correspond to the frame rate), an audio detection rate which defines the rate at which audio is processed for detection (e.g., an audio detector rate indicative of the rate at which recorded audio is passed through an audio detector such as a gunshot detector), a threshold limit of acceptable false positive detections such as a threshold confidence score, and a compression ratio, so on. The compression ratio is a measurement of the relative reduction in size of a data file produced by a data compression algorithm. Thus, the size of the image files, video files, and/or the audio files associated with the images, videos, and/or audio 2081 generated by the camera 10 may be reduced in accordance with a compression ratio.

With reference to FIG. 2D, the image capture device 2202 and the audio capture device 2204 (or the image capture device 2202 including the audio capture device 2204) may be collectively referred to as an audiovisual capture device 3000 of the camera 10. With continued reference to FIG. 2D, the image capture device 2202, the audio capture device 2204 and the processing device 202 may be collectively referred to as an audiovisual (AV) generation system 2000 of the camera 10. The AV generation system 2000 may be said to “generate” images, videos, and/or audio 2081 and which includes the capture of the images, videos, and/or audio 2081 by the audiovisual capture device 3000 and in some cases at least part of the processing of the images, videos and/or audio 2081 by the processing device 202 of the AV generation system 3000. The AV generation system 2000 may be said to be configured to generate (capture or capture and at least partly process) the images, videos, and/or audio 2081 in accordance with audiovisual generation parameters. The audiovisual generation parameters include at least one of the aforementioned audiovisual capture parameters (which include image capture parameters and audio capture parameters) and the aforementioned audiovisual processing parameters (which include image processing parameters and audio processing parameters).

In some cases, the audiovisual processing of the images, videos, and/or audio 2081 may be carried out in whole or in part on the camera 10, depending on operational requirements and constraints, including if there is sufficient power. In other cases, the audiovisual processing of the images, videos, and/or audio 2081 may be carried out in whole or in part on the server 20. In the case where these functions are to be performed in whole on the server 20, the detection rate of the AV generation system 2000 may be zero such that the AV generation system 2000 is configured to generate images, videos, and/or audio 2081 by capturing images, videos, and/or audio 2081 without processing the captured images, videos, and/or audio 2081.

The images, videos, and/or audio 2081 can be sent in the form of datagrams (packets) over a wireless link via the network interface 206 and the wireless transceiver 218. Proper addressing of the datagrams can allow them to be routed by the data network 30 to the server 20. Transmission of the images, videos, and/or audio 2081 can be carried out in accordance with specific transmission parameters. The transmission parameters include at least one of a data transmission setting indicative of whether real-time data transmission to the server 20 is enabled, a data consumption setting indicative of whether wireless data consumption is enabled, a threshold limit for an amount of data consumed over a given time period, bandwidth, latency (time between image capture and transmission to the server 20), duration of transmission (or transmission duty cycle), modulation scheme, and data rate. When the camera 10 is initially set up, the transmission parameters may be set to respective default values.

In some cases, the camera 10 may be configured to transmit generated images, videos, and/or audio 2081 to the server 20 in near real-time or real time. In other cases, the camera 10 may be configured to store the generated images, videos, and/or audio 2081 in the memory 208. In such cases, the camera 10 may provide an indication to the server 20 that images, videos, and/or audio 2081 have been stored in the memory 208 such that the server 20 may retrieve the stored images, videos, and/or audio 2081 as needed. Thus, a data transmission setting may be indicative of whether real-time data transmission to the computing apparatus is enabled. In some cases, the camera 10 may be configured to transmit generated images, videos, and/or audio 2081 to the server 20 by consuming wireless data. For instance, the camera 10 may be configured to transmit generated images, videos, and/or audio 2081 to the server 20 by consuming wireless cellular data. In other cases, the camera 10 may be configured to store the generated images, videos, and/or audio 2081 in the memory 208. In such cases, the camera 10 may be precluded from transmitting the generated images, videos, and/or audio 2081 to the server 20 by consuming wireless cellular data (e.g., wireless cellular data). Thus, a data consumption setting may be indicative of whether wireless data consumption is enabled. A threshold limit for an amount of data consumed over a given time period may establish a limit for how much data the camera 10 may be permitted to use to transmit generated images, videos, and/or audio 2081 to the server 20. The bandwidth refers to a frequency range between a lowest and a highest attainable frequency, which defines a channel capacity of a wireless/wired communication path/link established between the camera 10 and the server 20. The latency refers to the amount of time it takes for a captured image to be sent to (or arrive at) the server 20 via the network 30. The transmission duty cycle means how much percent of the time the camera 10 transmits the generated images, videos, and/or audio 2081 to the server 20. The modulation scheme determines how bits are mapped to the phase and amplitude of transmitted signals between the camera 10 and the server 20. The modulation scheme may include orthogonal frequency-division multiplexing (OFDM), filter bank multi-carrier (FBMC), universal filtered multi-carrier (UFMC), generalized frequency division multiplexing (GFDM), filtered OFDM (f-OFDM), and so on. The OFDM is implemented in Long Term Evolution (LTE) wireless communication, and the FBMC, UFMC, GFDM, and f-OFDM are applied in fifth-generation (5G) wireless communication. The data rate defines a transmission rate between the camera 10 and the server 20.

In some applications, the storage unit 208 may store configurations (e.g., sets of values) of the audiovisual generation parameters and/or the transmission parameters. It should be appreciated that the aforementioned list of audiovisual generation parameters and transmission parameters is not intended to be exhaustive. Still other audiovisual generation parameters and transmission parameters exist and will be apparent to those of ordinary skill in the art.

The processing system 200 may also include an instruction memory 210, which may include a volatile or non-volatile memory (e.g., a flash memory, a random-access memory (RAM), a read-only memory (ROM), an erasable programmable ROM (EPROM), an electrically erasable programmable ROM (EEPROM), a flash memory and a CD-ROM, to name a few non-limiting possibilities). The instruction memory 210 may store instructions for execution by the processing device 202, such as to carry out example methods described in the present disclosure. The instruction memory 210 may store other software (e.g., instructions for execution by the processing device(s) 202), such as an operating system and other applications/functions.

In some examples, execution of the instructions stored in the memory 210 result in the processing system 200 regulating at least one of the aforementioned audiovisual generation parameters (i.e., image capture parameters, audio capture parameters, image processing parameters, and/or audio processing parameters) and/or at least one of the aforementioned transmission parameters.

In addition, the processing system 200 may include a replenishable power supply 212, which is referred to as an “off-grid” power supply. The replenishable power supply 212 may be a battery, which is coupled to a solar panel 224 such that the battery could be replenished. Thus, the camera 10 can be a solar-powered camera, which could be powered by sunlight, through electricity generated by the solar panel(s) 224. In a non-limiting example, the solar panel 224 may include a 10″×6″ panel producing 5V at 1 A. Manufacturers of such solar panels include Viewzone, Eufy, Lorex, etc.

In other embodiments, the processing system 200 may include a power supply 211, which is referred to as an “on-grid” power supply. For instance, with reference to FIG. 2C, the power supply 211 can be connected to the utility grid 225.

There may be a bus 217 providing communication among the components of the processing system 200, including the processing device 202, the I/O interface 204, the network interface(s) 206, storage unit 208, memory 210 and replenishable power supply 212. The bus 217 may be any suitable bus architecture including, for example, a memory bus, a peripheral bus and/or a video bus.

Additional components may be provided. For example, the camera 10 may include an output device 222 such as a display and/or a visual or audible alarm, which may be controlled by the processing system 200.

The camera 10 may additionally communicate with a computer or other user device over a physical link such as a data port (e.g., USB port), which can occur during device setup or diagnostics testing, for example.

In some embodiments, the camera 10 may be configured to communicate its battery charge level, data consumption level and/or its operating parameters (i.e., its audiovisual generation parameters and/or transmission parameters) to the server 20 via the data network 30. The camera 10 may also be configured to respond to messages from the server 20 to change its operating parameters.

### Server 20

FIG. 2E is block diagram of an example simplified processing system 300, which may be used to implement the server 20. Although FIG. 2E may show a single instance of each component, there may be multiple instances of each component in the server 20.

The server 20 may also be referred to as a centralized device (or centralized server), which receives, stores, and/or processes images, photos, videos and/or audio from the camera 10 and other cameras. For example, the server 20 may run a security software platform that gathers images and video (which may include audio) received from various cameras 10 in a common neighborhood, processes them to identify events or entities, and provides either a report or a graphical display for security personnel or law enforcement departments. The server 20 may also run a remote control operation that controls various functions of the camera 10 over the data network 30. The server 20 may be a cloud server running in a cloud computing environment.

The processing system 300 may include one or more network interfaces 306 for wired or wireless communication with the communication network 30 or peer-to-peer communication with the processing system 200 of the camera 10.

The processing system 300 may include a processing device 302, such as a central processing unit (CPU), a graphics processing unit (GPU), a tensor processing unit (TPU), a neural processing unit (NPU), an application-specific integrated circuit (ASIC), a field-programmable gate array (FPGA), a dedicated logic circuitry, or combinations thereof.

The processing system 300 may also include a storage unit 308, which may include a mass storage unit such as a solid state drive, a hard disk drive, a magnetic disk drive and/or an optical disk drive. In some examples, the storage unit 308 may store images, videos, and/or audio 2081 received from the cameras 10 over the network 30.

The processing system 300 may also include an instruction memory 310, which may include a volatile or non-volatile memory (e.g., a flash memory, a random-access memory (RAM), a read-only memory (ROM), an erasable programmable ROM (EPROM), an electrically erasable programmable ROM (EEPROM), a flash memory and a CD-ROM, to name a few non-limiting possibilities). The instruction memory 310 may store instructions for execution by the processing device 302, such as to carry out example methods described in the present disclosure. The instruction memory 310 may store other software (e.g., instructions for execution by the processing device(s) 302), such as an operating system and other applications/functions.

In addition, the processing system 300 may include a power supply 312. The power supply 312 need not be an “off-grid” power supply. In particular, the power supply 312 can be connected to the utility grid.

Additional components may be provided. For example, the processing system 300 may comprise an input/output interface 304 for interfacing with a user via input and/or output devices 320, 322, such as a display, keyboard, mouse, touchscreen and/or haptic module, for example.

There may be a bus 317 providing communication among components of the processing system 300, including the processing device 302, input/output interface 304, network interface 306, storage unit 308, and/or memory 310. The bus 317 may be any suitable bus architecture including, for example, a memory bus, a peripheral bus and/or a video bus.

In some examples, some data used by the methods disclosed herein may be stored at the server 20 and may be stored additionally or alternatively at the camera 10. For example, this may include the battery charge level of the camera 10, the audiovisual generation parameters and the transmission parameters, the camera position and the camera angle/field of view.

### Resource Consumption

During operation, the camera 10 is configured to consume resources. Non-limiting examples of resources include power or data. For instance, the camera 10 is configured to consume power from the replenishable supply 212 or the on-grid power supply 211. Additionally, the camera 10 is configured to consume data via the data network 30. For instance, the camera 10 may be configured to consume wireless data via the data network 30. The wireless data may be wireless cellular data.

Consumption of resources by the camera 10, such as power and data, is a result of resource consumption parameters being applied to camera. In one embodiment, the resource consumption parameters include power consumption parameters. In another embodiment, the resource consumption parameters include data consumption parameters.

The AV generation system 2000 of the camera 10 is operable to generate at least one of images, videos, and/or audio 2081 in accordance with at least one power consumption parameter that affects power utilization by the camera 10. Non-limiting examples of power consumption parameters include the aforementioned audiovisual activation parameters (e.g., an image capture activation setting indicative of whether image capture is enabled, an audio capture activation setting indicative of whether audio capture is enabled) and the aforementioned audiovisual generation parameters (i.e., frame rate, image resolution, number of images captured over a given time period, activation of flash, sampling rate, detection rate, and a threshold limit of acceptable false positive detections), to include a few non-limiting possibilities.

The network interface 206 of the camera 10 is operable to transmit to the server 20 images, videos, and/or audio 2081 generated by the camera 10, in accordance with at least one data consumption parameter that affects data utilization by the camera 10. Non-limiting examples of data consumption parameters include the aforementioned transmission parameters (e.g., a compression ratio, a data transmission setting indicative of whether real-time data transmission to the computing apparatus is enabled, a data consumption setting indicative of whether wireless data consumption is enabled, a threshold limit for an amount of data consumed over a given time period, bandwidth, transmission duty cycle, modulation scheme, data rate and a latency between generation and transmission.)

It is to be appreciated that data consumption parameters may also affect power utilization by the camera 10. As such, power consumption parameters may also include the aforementioned data consumption parameters.

In some embodiments, the resource consumption parameters associated with a given camera 10 may be given an overall attribute such as “high” and “low.” In some cases, it may be desirable to configure the camera 10 to regulate the amount of resources consumed by the camera 10. In some embodiments, the camera 10 is configured to operate in multiple resource consumption modes. In this embodiment, the resource consumption modes may include “low resource consumption mode” and “high resource consumption mode.”

For instance, one or more of the power consumption parameters may be applied to the camera 10 so as to regulate the amount of power consumed by the camera 10. As such, the camera 10 may be configured to operate in a low resource consumption mode of operation that is a low power consumption mode of operation and a high resource consumption mode of operation that is a high power consumption mode of operation. Specifically, the power consumption parameters may be applied to the camera 10 such that the camera 10 operates in “low power consumption mode” or in “high power consumption mode.” The camera 10 may operate in low power consumption mode to reduce an amount of power consumed by the camera 10. In one example, an off-grid cameras 10 may operate in low power consumption mode so as to reduce the amount of power consumed from the off-grid power supply (e.g., the replenishable power supply 212.)

When the camera 10 is in high power consumption mode, the camera 10 consumes more power from the off-grid power supply than in low power consumption mode. In some cases, the low power consumption mode may be associated with power consumption of no more than X watts and high power mode may be associated with power consumption of no less than Y watts, with Y being greater than X. The number of watts may be measured instantaneously during operation in a given one of the modes or may be integrated over a period of time (e.g., 1 second, 30 seconds, 5 minutes) of continuous operation in the given one of the modes, in which case reference to power consumption may be taken to be the average power consumption over the relevant period of time.

In still other cases, low power consumption mode may be associated with peak power consumption of up to no more than X watts and high power consumption mode may be associated with peak power consumption of up to no more than Y watts, with Y being greater than X.

In another example, in one example, one or more of the data consumption parameters may be applied to the camera 10 so as to regulate the amount of wireless data consumed by the camera 10. As such, the camera 10 may be configured to operate in a low resource consumption mode of operation that is a low data consumption mode of operation and a high resource consumption mode of operation that is a high data consumption mode of operation. Specifically, the data consumption parameters may be applied to the camera 10 such that the camera 10 operates in “low data consumption mode” or in “high data consumption mode.” The camera 10 may operate in low data consumption mode to reduce an amount of data consumed by the camera 10. An off-grid camera 10 or an on-grid camera 10 may operate in low data consumption mode so as to reduce the amount of data consumed via the data network 30. This may prevent the camera 10 from constantly transferring data to the server 20 which in turn may reduce the costs associated with utilizing wireless data to transfer data to the server 20 or may regulate the amount of data sent to the server 20 so as to manage the amount of storage required to store the data received from the camera 10 in the memory 308 of the server 20.

When the camera 10 is in high data consumption mode, the camera 10 consumes more data than in low data consumption mode. In some cases, low data consumption mode may be associated with data consumption of no more than X megabytes over a given time period and high data consumption mode may be associated with data consumption of no less than Y megabytes over a given time period, with Y being greater than X. The amount of data may be measured instantaneously during operation in a given one of the modes or may be integrated over a period of time (e.g., 1 second, 30 seconds, 5 minutes) of continuous operation in the given one of the modes, in which case reference to data consumption may be taken to be the average data consumption over the relevant period of time.

In still other cases, low power consumption mode may be associated with peak data consumption of up to no more than X megabytes and high data consumption mode may be associated with peak data consumption of up to no more than Y megabytes, with Y being greater than X.

In some circumstances, it may be desirable to configure the camera 10 to operate in a high resource consumption mode of operation rather than a low resource consumption mode of operation.

For instance, an event may be unfolding in the vicinity of the camera 10 and it may be desirable to record images, videos, and/or audio 2081 and send it back rapidly to the server 20. In this case, it may be desirable to increase “transmissibility” of the images, videos, and/or audio 2081 generated by the camera 10 to the server 20. Used herein, “transmissibility” is an indicator of how rapidly images, videos, and/or audio 2081 are sent to the server 20. The camera 10 may be configured such that transmissibility of the images, videos, and/or audio 2081 generated by the camera 10 to the server 20 can be adjusted (e.g., increased, decreased). For instance, the camera 10 may be configured such that transmissibility of the generated images, videos, and/or audio 2081 is “high” or “low” For example “high transmissibility” may be associated with the network interface 206 being configured to send generated images, videos, and/or audio 2081 at a higher bandwidth or at a higher update rate (lower latency), to send a larger percentage of the images, videos, and/or audio 2081 generated by AV generation system 2000, to enable real-time sending of the generated images, videos, and/or audio 2081 to the server 20, to enable consumption of wireless data (e.g., to enable the consumption of wireless cellular data), to use a higher duty cycle, to change the modulation scheme and/or to increase the data rate. As such, one or more data consumption parameters (e.g., one or more transmission parameters) may be applied to the network interface 206 such that the camera 10 is configured to operate in high data consumption mode to increase transmissibility of the generated images, videos, and/or audio 2081 to the server 20.

In the present disclosure, it is considered that an increase in the transmissibility of the images, videos, and/or audio 2081 generated by the camera 10 and the data consumption of the camera 10 correlates positively, i.e., the higher the transmissibility of the images, videos, and/or audio 2081 generated by a given camera, in general, the greater the amount of data consumed by the given camera. That is to say, if one were to constrain each of the data consumption parameters to a scale of 1 to 10 and if one were to take the average of those parameters in a specific instantiation and plot it against data consumption of the camera, and if one were to carry out a linear best fit through the points obtained for various instantiations (i.e., various possible values of the data consumption parameters and the corresponding data consumption), the resulting line (ax+b) would have a positive slope a.

For instance, in another example, an event may be unfolding in the vicinity of the camera 10 and it may be desirable to record images, videos, and/or audio 2081 in such fashion that there is an increased potential that valuable information may be extracted from the images, videos, and/or audio 2081 to address the event. Used herein, “extractability” is an indicator of potential that valuable information may be extracted from the images, videos, and/or audio 2081. The camera 10 may be configured such that extractability of the images, videos, and/or audio 2081 generated by the camera 10 can be adjusted (e.g., increased, decreased). For instance, the camera 10 may be configured such that extractability of the generated images, videos, and/or audio 2081 is “high” or “low” For example “high extractability” may be associated with the AV generation system 2000 being configured to capture images at a higher frame rate or resolution, to use flash more frequently, to increase the brightness of the flash, to increase the number of activations of the flash, to increase the number of images captured in a given time period, to increase the sampling rate, to decrease the compression rate utilized to compress the generated images, videos, and/or audio 2081, to increase the detection rate and/or to lower the confidence score. Additionally, extractability may be increased by enabling image capture or audio capture by the camera 10. As such, one or more power consumption parameters (e.g., one or more audiovisual generation parameters) may be applied to the AV generation system 2000 such that the camera 10 is configured to operate in high power consumption mode to increase extractability of the generated images, videos, and/or audio 2081. In the present disclosure, it is considered that an increase in extractability of the images, videos, and/or audio 2081 generated by the camera 10 and the power consumption of the camera 10 correlates positively, i.e., the higher the grade of the images, videos, and/or audio 2081 generated by a given camera, in general, the greater the amount of power consumed by the given camera. That is to say, if one were to constrain each of the power consumption parameters (e.g., resolution, frame rate, number of images taken, sampling rate, rate of activation of flash, brightness of flash, detection rate, confidence score) to a scale of 1 to 10 and if one were to take the average of those parameters in a specific instantiation and plot it against power consumption of the camera, and if one were to carry out a linear best fit through the points obtained for various instantiations (i.e., various possible values of the power consumption parameters and the corresponding power consumption), the resulting line (ax+b) would have a positive slope a.

### Camera Control Process

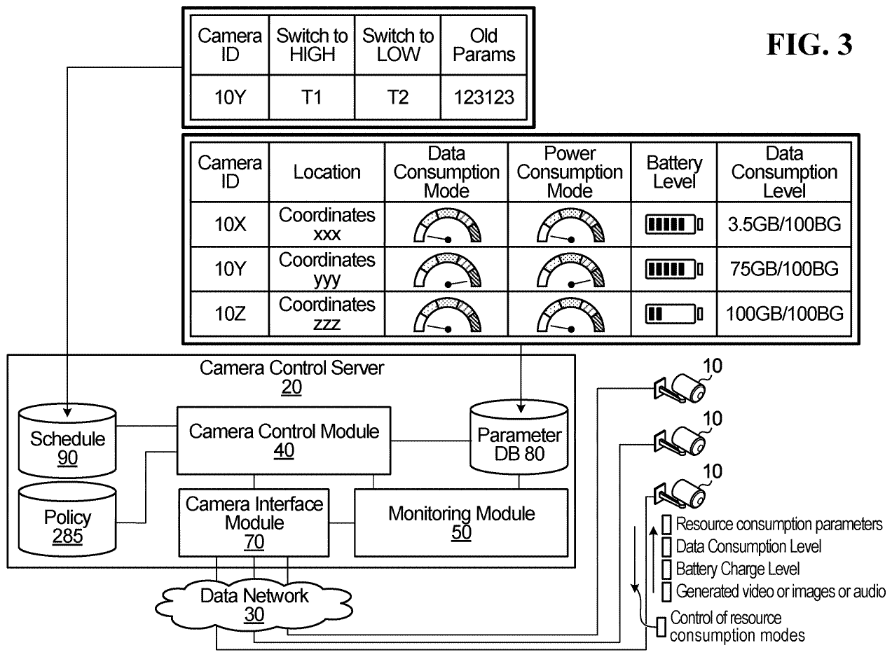

In some examples, execution of the instructions stored in the memory 310 results in the processing system 300 of the server 20 implementing a camera control module and a camera interface module. FIG. 3 is functional representation of the server 20, including a camera control module 40, a monitoring module 50, a parameter database 80, a policy database 60 and a camera interface module 70.

The camera interface module 70 is configured to manage communications between, on the one hand, the camera control module 40 and the monitoring module 50 and on the other, the cameras 10 via the data network 30.

The camera control module 40 is configured to carry out a camera control process. The camera control process is implemented to dynamically adjust consumption of resources by the camera 10 to switch between the aforementioned modes of resource consumption. The camera control process is implemented to dynamically switch between the aforementioned modes of resource consumption based on an event unfolding in the vicinity of the camera 10. To this end, the camera control module 40 has access to the resource consumption parameters of each of the cameras 10. The resource consumption parameters are stored in the parameter database 80, which is communicatively coupled to the camera control module 40.

In one embodiment, the resource consumption parameters associated with each camera 10 are pushed over the data network 30 by the camera 10 itself (possibly at different times or intervals), received at the monitoring module 50 via the camera interface module 70 and stored in the parameter database 80. In another embodiment, the monitoring module 50 can query the cameras 10 via the camera interface module 70 and the data network 30 and obtain the resource consumption parameters in response. The received parameters may be stored in the parameter database 80.

Furthermore, the parameter database 80 also stores information about a location, orientation and/or field of view for each of the cameras 10. The location can be expressed as coordinates in a reference plane shared amongst the cameras 10. The orientation can be expressed as a directional vector in this reference plane. The field of view may be expressed as a bounded area in the reference plane. The location, orientation and/or field of view stored in association with a given camera may remain fixed as long as the camera does not move or is not reoriented.

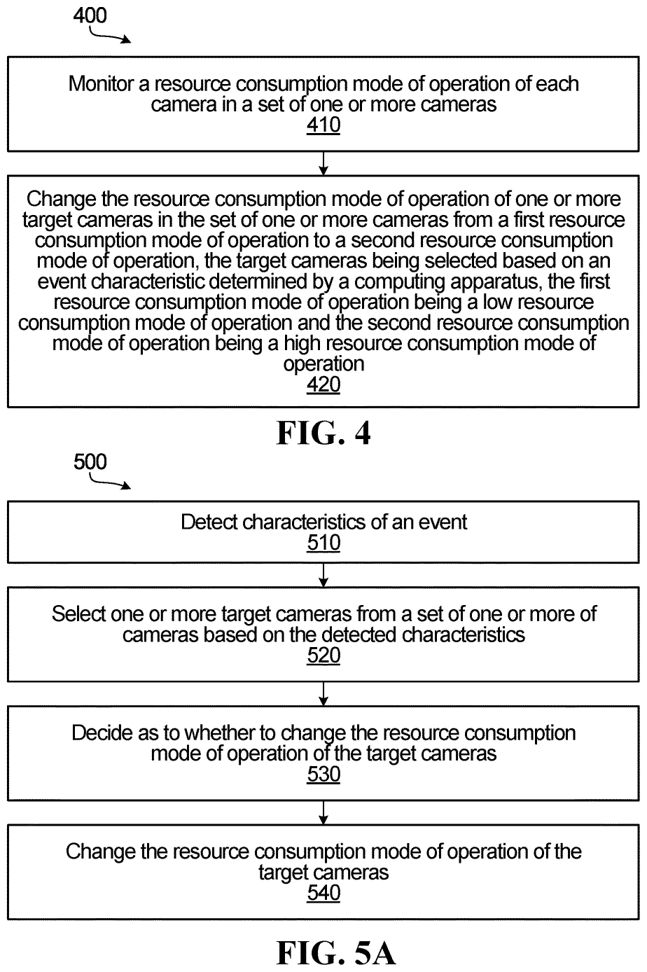

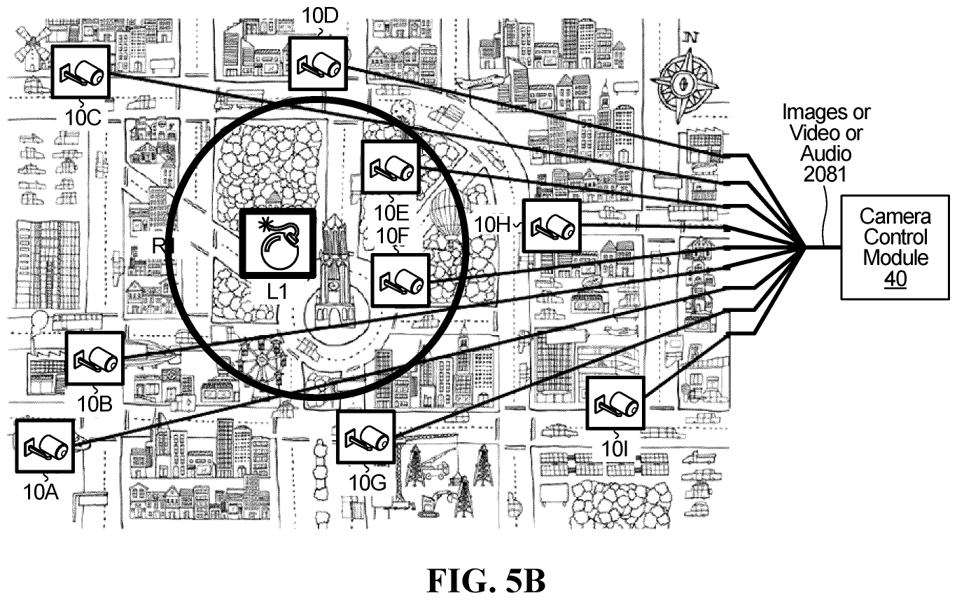

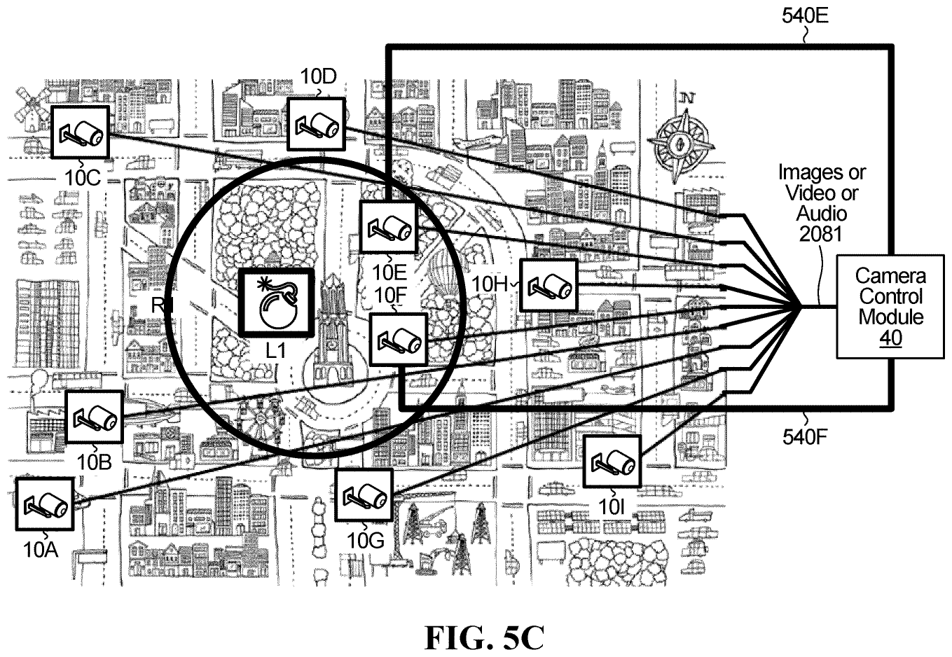

FIG. 5A is a conceptual diagram showing occurrence of an example event. In this example, the event is a bomb-threat event. FIG. 4 is a flowchart representing a camera control process 400 carried out by camera control module 40 in response to such an event.

In one example embodiment, FIG. 5A shows a set of cameras 10. In this example, the set of cameras 10 includes on-grid cameras and off-grid cameras. In other embodiments, every camera in the set of cameras may be an on-grid camera. In yet other embodiments, every camera 10 in the set of cameras 10 may be an off-grid camera. In yet other embodiments, the set of cameras 10 includes a single camera.

At step 410 of the camera control process 400, the camera control module 40 is configured to monitor the resource consumption mode of operation of one or more cameras 10 in the set of one or more cameras 10. For instance, the camera control module 40 may be configured to monitor a resource consumption mode of operation of each of the cameras in the set of one or more cameras 10. The camera control module 40 may be configured to monitor the resource consumption parameters stored in the parameter database 80 for each of the cameras 10 in the set of cameras 10.

At step 420 of the camera control process 400, the camera control module 40 is configured to change the resource consumption mode of operation of one or more target cameras 10 in the set cameras 10 from a first resource consumption mode of operation to a second resource consumption mode of operation. In one embodiment, the first resource consumption mode of operation is a low resource consumption mode of operation and the second resource consumption mode of operation is a high resource consumption mode of operation. As will be discussed further below, the target cameras are selected based on an event characteristic detected by the server 20.

In one embodiment, the low resource consumption mode of operation is a low data consumption mode of operation and the high resource consumption mode of operation is a high data consumption mode of operation. In another embodiment, the low resource consumption mode of operation is a low power consumption mode of operation and the high resource consumption mode of operation is a high power consumption mode of operation.

### Dynamic Change Process

To change the resource consumption mode of operation from the low resource consumption mode of operation to the high resource consumption mode of operation at step 420, the camera control module 40 is configured to carry out a dynamic mode change process 500. FIG. 5 is flowchart representing dynamic mode change process 500 carried out by camera control module 40 in response to change the resource consumption mode of operation of given ones of the set of cameras 10. FIGS. 5A through 5C facilitate understanding of the steps in the dynamic mode change process 500.

At step 510, the camera control module 40 is configured to detect characteristics of an event. Non-limiting examples of events may include a traffic-related event such as a vehicle collision, a kidnapping event, a bomb threat event, an explosion event, a fire event, an active shooter event, a shooting event, to name a few.

In some embodiments, the event characteristic may be detected by the server 20 based on processing of images, videos, and/or audio 2081 captured by one or more of the cameras 10. For instance, in some embodiments, the server 20 may carry out processing of the images, videos, and/or audio 2081 for example including motion detection, license plate detection, facial recognition, gunshot detection, voice recognition, speech recognition environmental sound recognition and so on. Thus, in this example of implementation, the event characteristic may be detected by the server 20 based on responding to contents of images, videos, and/or audio 2081 captured by a given one of the cameras in the set of cameras.

In other embodiments, a given one of the set of cameras may carry out processing of the images, videos, and/or audio 2081 for example including motion detection, license plate detection, facial recognition, gunshot detection, voice recognition, speech recognition environmental sound recognition and so on. Thus, in this example of implementation, the event characteristic may be detected by the server 20 based on responding to a result received from a given one of the set of cameras 10, the result created by the given one of the cameras 10 in the set of one or more cameras 10 further to the processing entity 200 of the given one of the cameras 10 in the set of one or more cameras 10 carrying out processing of captured images, videos, and/or audio 2081. The result may be a license plate detection, an object detection or a gunshot detection.

It should be understood that images, videos, and/or audio 2081 captured by a given camera 10 may be processed either partly at the given camera 10 and partly at the camera control module 40 of the server 20, or entirely at the given camera 10, or entirely at the camera control module 40 of the server 20.

In yet other embodiments, the event characteristic may be detected by the server 20 based on responding to a backend input received by the server 20. As used herein, “backend input” is an input indicative of an event. Non-limiting examples of backend input include a computer-aided dispatch call, a call received from an emergency service or an AMBER (America's Missing: Broadcast Emergency Response) Alert, to name a few.

An event characteristic is a detectable characteristic of an event that is used to select cameras of the set of cameras 10 that may be in the vicinity of the event. The vicinity of the event may be defined as a threshold distance from the event that enables the camera 10 to obtain information related to the event. For example, an event characteristic detected by the server 20 may include a location (of the event), a location of an object, a direction of travel of an object and a speed of travel of an object, to name a few.

By way of non-limiting example, and with reference to FIG. 5B, consider that a bomb threat-related event occurs at a location L1. The detected characteristics of the event could include the coordinates of the location L1. Another example of an event could include a traffic-related event such as a vehicle collision and/or detection of the license plate of a speeding vehicle, in which case the characteristics of the event could be a direction and speed of the speeding vehicle. Yet another example of an event could include a shooting and the detected characteristics of the event could include a direction and speed of a purported assailant or a purported origin of the shot. Naturally, these examples are non-limiting and other examples of events and detected characteristics are possible and fall within the notions covered in the present disclosure.

At step 520 of the dynamic mode change process 500, the camera control module 40 is configured to select a subset of the cameras 10 (referred to as “target cameras”) based on the characteristics of the event detected at step 510.

In one example, the target cameras are those cameras 10 of the set of cameras 10 whose field of view includes or is proximity to the location or of the location of the object determined at step 510. In another example, the target cameras are those cameras 10 of the set of cameras 10 whose location and pickup range are suitable to capture a sound source at the location or at the location of the object determined at step 510. As used herein, “pickup range” is a distance from a sound source at which the audio capture device 2204 is capable of capturing sound. It is to be understood that the pickup range of the audio capture device 2204 changes based on several factors such as the directionality of the sound, the level of background noise, local air pressure, the energy at which a soundwave travels, etc. The pickup range may be deduced empirically based on testing the audio capture device 2204 or may be based on the specifications of the audio capture device 2204.

The location or the location of the object may be stored as coordinates in the memory 308 of the server 20. As previously discussed, the parameter database 80 also stores information about a location, orientation and/or field of view for one or more or each of the cameras 10. The location can be expressed as coordinates in a reference plane shared amongst the cameras 10. The orientation can be expressed as a directional vector in this reference plane. The field of view may be expressed as a bounded area in the reference plane. The location, orientation and/or field of view stored in association with a given camera may remain fixed as long as the camera does not move or is not reoriented. The parameter database 80 may also store information about the pickup range of one or more or each of the cameras 10. The pickup range can be expressed as a distance (e.g., a radius surrounding the camera 10). Thus, the camera control module 40 may be configured to select a target camera from the set of cameras 10 based on the information stored in memory 308.

In this example, it is cameras 10E and 10F that are selected based on the event characteristics detected by the server 20. In this case, the server 20 receives a backend input indicative of a bomb-scare event and detects the coordinates associated with location L1 as well as a radius R1 associated with the speed and direction of motion of a suspect walking away from the location L1. Based on the location L1 and radius R1, and the information regarding cameras 10A, 10B, 10C, 10D, 10E, 10F, 10G, 10H and 101 stored in memory 308, the camera control module 40 selects the cameras 10E, 10F as target cameras 10. In this case, cameras 10E and 10F are selected based on their position within the radius R1 and their proximity to location L1.

At step 530 of the camera control process 400, a decision is made as to whether to change the resource consumption mode of operation of the target cameras (in this case, cameras 10E, 10F). If cameras 10E, 10F are already operating in high resource consumption mode of operation (e.g., high power consumption mode of operation and/or high data consumption mode of operation), then there is no need to change the operational state of the cameras 10E, 10F. As such, a decision will be made that the resource consumption mode of operation of the target cameras 10E, 10F does not need to be changed. In this case, the resource consumption parameters of the target cameras 10E, 10F do not need to be changed.

If cameras 10E, 10F are operating in the low resource consumption mode of operation (e.g., low power consumption mode and/or low data consumption mode), then the operational state of the cameras 10E, 10F must be changed. As such, a decision will be made that the resource consumption mode of operation of the target cameras 10E, 10F needs to be changed. In this example, at least one of the resource consumption parameters of the target cameras 10E, 10F will be changed at step 540.

In some cases, even if cameras 10E, 10F are operating in the low resource consumption mode of operation (e.g., low power consumption mode and/or low data consumption mode of operation), it may be determined that the there is no need to change operational state of the cameras 10E, 10F. For instance, if the cameras 10E, 10F are on-grid cameras, it may be determined that there is no need to change the operational sate of the cameras 10E, 10F to operate in a high power mode as the amount of power consumed by the cameras 10E, 10F is irrelevant since the power supply 211 is an on-grid power supply.

At step 540, the resource consumption mode of operation of the target cameras 10E, 10F are changed.

To change the resource consumption mode of operation of the cameras 10E, 10F from a low data consumption mode of operation to a high data consumption mode of operation, the camera control module 40 may change one or more data consumption parameters. To change the resource consumption mode of operation of the cameras 10E, 10F from a low data consumption mode of operation to a high data consumption mode of operation, the camera control module 40 may decrease a data compression ratio or a latency used by the network interface 206 to transmit the generated images, videos, and/or audio 2081 to the server 20. In some cases, to change the resource consumption mode of operation of the cameras 10E, 10F from a low data consumption mode of operation to a high data consumption mode of operation, the camera control module 40 may enable real-time data transmission to the server 20 or wireless data consumption by the network interface 206 to transmit the generated images, videos, and/or audio 2081 to the server 20. In some cases, to change the resource consumption mode of operation of the cameras 10E, 10F from a low data consumption mode of operation to a high data consumption mode of operation, the camera control module 40 may increase a threshold limit for an amount of data consumed over a given time period, a bandwidth, a transmission duty cycle and/or a data rate used by the network interface 206 to transmit the generated images, videos, and/or audio 2081 to the server 20. In other cases, to change the resource consumption mode of operation of the cameras 10E, 10F from a low data consumption mode of operation to a high data consumption mode of operation, the camera control module 40 may change a modulation scheme used by the network interface 206 to transmit the generated images, videos, and/or audio 2081 to the server 20.

To change the resource consumption mode of operation of the cameras 10E, 10F from a low power consumption mode of operation to a high power consumption mode of operation, the camera control module 40 may change one or more power consumption parameters. In some cases, to change the resource consumption mode of operation of the cameras 10E, 10F from a low power consumption mode of operation to a high power consumption mode of operation, the camera control module 40 may enable image capture and/or enable audio capture. In some instances, to change the resource consumption mode of operation of the cameras 10E, 10F from a low power consumption mode of operation to a high power consumption mode of operation, the camera control module 40 may increase a frame rate, an image resolution, a number of images captured over the given time period, a brightness of the flash, an activation of flash used and/or a sampling rate used by the AV generation system 2000 to images, videos, and/or audio 2081. In some instances, to change the resource consumption mode of operation of the cameras 10E, 10F from a low power consumption mode of operation to a high data consumption mode of operation, the camera control module 40 may increase a detection rate used by the processing entity to process the generated images, videos, and/or audio 2081, and/or the threshold limit of acceptable false positive detections.

Additionally, or alternatively, in another embodiment, in high power consumption mode, the camera 10 is configured to capture video, whereas in low power consumption mode, the camera 10 is configured to capture still images. Thus, to change the resource consumption mode of operation of the cameras 10E, 10F from a low power consumption mode of operation to a high power consumption mode of operation, the camera control module 40 may cause the cameras 10E, 10F, to switch from taking still images to video.

It is to be understood that, to change the resource consumption mode of operation of the cameras 10E, 10F from a low resource consumption mode of operation to a high resource consumption mode of operation, the camera control module 40 may change other resource consumption parameters (e.g., other data consumption parameters and/or power consumption parameters) and that the above-provided examples should not be considered as limiting. Moreover, it is also understood to change the resource consumption mode of operation of the cameras 10E, 10F from a low resource consumption mode of operation to a high resource consumption mode of operation, the camera control module 40 may change a first set of resource consumption parameters for camera 10E and a second set of resource consumption parameters for camera 10F, the first set of resource consumption parameters may be different from the second set of resource consumption parameters. Furthermore, the set of resource consumption parameters may include a single resource consumption parameter.

Accordingly, and with reference to FIG. 5D, the camera control module 40 may be configured to send a command 540E, 540F to cameras 10E, 10F, respectively, to cause the cameras switch into a high resource consumption mode of operation.

In order to cause a given camera to enter high resource consumption mode of operation, the commands 540E, 540F sent to cameras 10E, 10F could request an increase in one or more of the aforementioned resource consumption parameters.

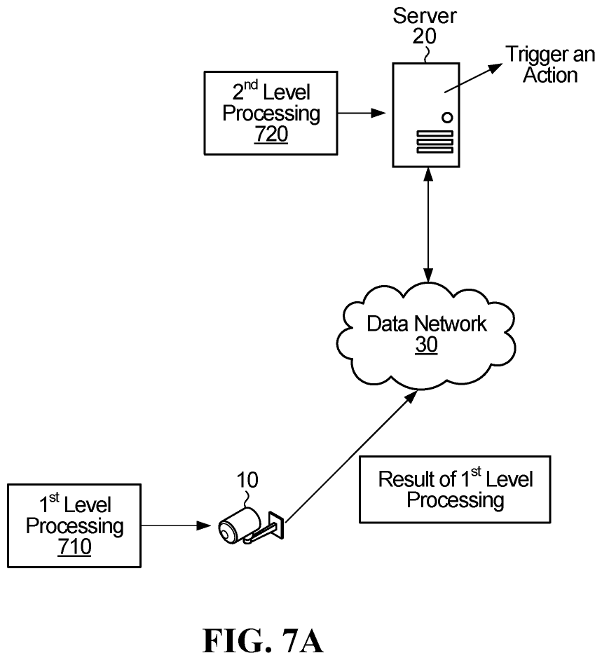

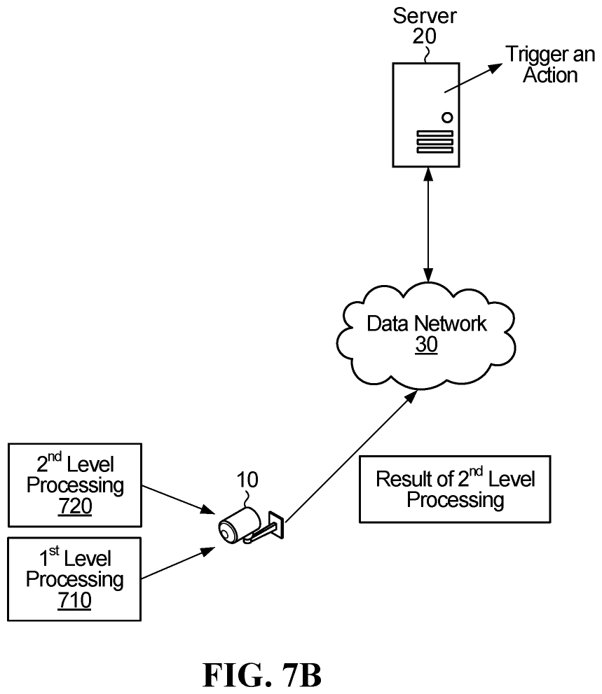

In a still further example, consider that image, video, and/or audio processing may be separated into a sequence of operations that can be executed at the camera 10 or at the server 20. In low power consumption mode, a smaller number of such operations in the sequence are performed at the camera 10 than in high power consumption mode, with the balance of operations (if any) being performed at the server 20. For example, if the sequence of operations associated with image and/or video and/or audio processing includes first-level processing 710 followed by second-level processing 720, the camera 10 operating in low power consumption mode (see FIG. 7A) may perform only the first-level processing 710, with the second-level processing 720 being performed at the server 20, whereas in high power consumption mode (see FIG. 7B), the camera 10 may perform both the first-level processing 710 and the second-level processing 720.

In one embodiment, the processing entity 202 of a given one of the one or more target cameras 10 is configured for carrying out first-level processing of captured images, videos, and/or audio 2081 to create a result. When the given one of the one or more target cameras 10 is in high power consumption mode, the processing entity 202 is configured for performing second-level processing on the result of the first-level processing and for sending a result of the second-level processing to the server 20 via the wireless network interface 206. When the given one of the one or more target cameras 10 is in low power consumption mode, the processing entity 202 is configured for sending the result of the first-level processing to the server 20 via the wireless network interface 206 without performing the second-level processing on the result of the first-level processing.

In a non-limiting embodiment, the first-level processing 710 may include object and/or event detection and the second-level processing 720 may include object and/or event recognition. In this context, the object may include a face, a car make/model or a license plate and the event may include a gunshot or speech, to name a few non-limiting possibilities. By way of the first-level processing, the object and/or event is detected, and therefore a result of the first-level processing could be a position of the suspected object or a bounding box containing the suspected object (e.g., person, license plate, vehicle) or detection of a source sound (without recognition of the sound), and the second-level processing (involving object recognition, which could also include optical character recognition) is applied to the result of the first-level processing, leading to a result that could be the identity of a person, the characters of a license plate, the make and model of a vehicle, gunshot recognition, speech recognition etc. Once the second-level processing 720 has taken place, an action may be triggered, which can include further investigation, summoning the authorities, issuing an alert, etc.

In another embodiment, the first-level processing 710 applied to a stream of captured images could be the identification of a relevant subset of images (i.e., a reduction in the number images) based on criteria such as contrast, motion, ambient light, etc. In this case, second-level processing 720 is performed only on the subset of images that result from the first-level processing. In such an embodiment, second-level processing 720 may include both object and/or event detection and object and/or event recognition.

In another embodiment, in some cases, first level processing 710 may include processing to detect a given condition (e.g., detection of a sound, detection of an object, etc.) by a first detector and the results of the first level processing 710 are transmitted to a second detector which carries out second level processing 720. In some cases, second-level processing 720 is performed only if the results of the first level processing meet a particular criterion.

In some embodiments, the camera 10 may be configured to communicate its battery charge level to the server 20 via the data network 30. In one embodiment, the battery charge level associated with each camera is pushed over the data network 30 by the camera itself (possibly at different times or intervals), received at the monitoring module 50 via the camera interface module 70 and stored in the parameter database 80. In another embodiment, the monitoring module 50 can query the cameras 10 via the camera interface module 70 and the data network 30 and obtain the battery charge level in response. Depending on the embodiment, the battery charge level can be stored as a percentage or on a scale of 1 to 10, or as a coarse level (such as high, medium and low), for example.

In a non-limiting embodiment, changing the resource consumption mode of operation of a given one of the one or more target cameras is carried out irrespective of the battery charge level of the given one of the one or more target cameras.

In some embodiments, the camera 10 may be configured to communicate its data consumption level to the server 20 via the data network 30. The data consumption level is an indication of the amount of data consumed by the camera over a given period of time. The data consumption level may defined with respect to a threshold level (e.g., above a threshold level or below a threshold level, where the threshold level X may be defined as an amount of data measured in bytes, megabytes, terabytes, etc.). The data consumption level may be expressed as a percentage of a total threshold limit (e.g., 50% of X limit, where X may be defined as an amount of data measured in bytes, megabytes, terabytes, etc.) or a value on a scale of 1 to 10. In one embodiment, the data consumption level associated with each camera is pushed over the data network 30 by the camera itself (possibly at different times or intervals), received at the monitoring module 50 via the camera interface module 70 and stored in the parameter database 80. In another embodiment, the monitoring module 50 can query the cameras 10 via the camera interface module 70 and the data network 30 and obtain the data consumption level in response. Depending on the embodiment, the data consumption level can be stored as an amount of data such as a byte, a megabyte, a terabyte, as a value on a scale of 1 to 10, or as a percentage, for example.

In a non-limiting embodiment, changing the resource consumption mode of operation of a given one of the one or more target cameras is carried out irrespective of a data consumption level of the given one of the target cameras 10Y, 10Z.

### Additional Steps to the Camera Control Process

The cameras 10E, 10F may subsequently remain in high power consumption mode until the battery 212 is depleted. The cameras 10E, 10F may subsequently remain in high data consumption mode until a threshold level of data consumption has been reached.

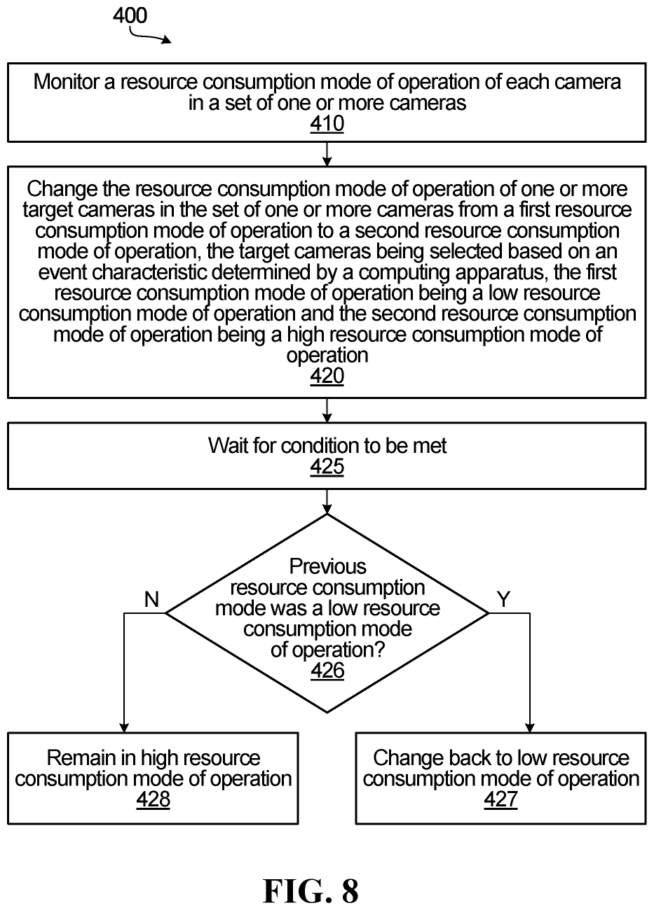

Alternatively, in one non-limiting embodiment of the camera control process 400, and with reference to FIG. 8, the camera 10 or the server 20 may wait for a condition to be met and then decide what to do next. If the camera 10 had been in a low resource consumption mode of operation at the time of determining the event characteristic (which is recorded in the parameters database 80 at step 410), then after the condition is met, the camera control module 40 may switch the camera 10 back into low resource consumption mode, at step 427.

In one embodiment, the condition verified may be the passage of a certain amount of elapsed time. The certain amount of elapsed time may correspond to how much time is considered adequate to upload images, videos, and/or audio 2081 of high extractability that could provide the server 20 with a useful time window for extracting valuable information from the images, videos, and/or audio 2081 transmitted by the camera 10. The certain amount of elapsed time may correspond to how much time is considered adequate to provide the processing device 202 with a useful time window for assessing the situation. This could be on the order of 10 seconds, 30 seconds, 5 minutes or any other period of time, which could vary according to factors such as the battery charge level.

In another embodiment, the condition verified at step 426 may be receipt of a “relinquish” signal.

In some instances, the relinquish signal may be generated by the server 20, which tells the camera 10 to switch back into its previous mode of operation. The relinquish signal may be generated by the server 20 after the server 20 (or a user thereof) has assessed the event.

In other instances, the relinquish signal may be produced internally by the camera 10 based on processing of the images, videos, and/or audio 2081 captured by the image capture device 2202 and/or the audio capture device 2204. The relinquish condition may be based on an assessment by the camera 10 that the event is over. In this case, the server 20 may receive an input from a given one of the one or more target cameras 10 indicative of a change from high consumption mode to low consumption mode further to a determination by the given one of the one or more target cameras 10 that a relinquish condition has been met. The server 20 may update the parameter database 80 stored in a memory 308 of the server 20 to reflect this change of mode of operation.

Of course, if the camera 10 had been in high consumption mode at the time the characteristics of the event were detected, then no particular action needs to be taken and the camera 10 can remain in high consumption mode at step 428 until possibly another process run by the camera control module 40 makes a change.

Camera Control Process Taking into Consideration an Anticipated Trajectory of an Object

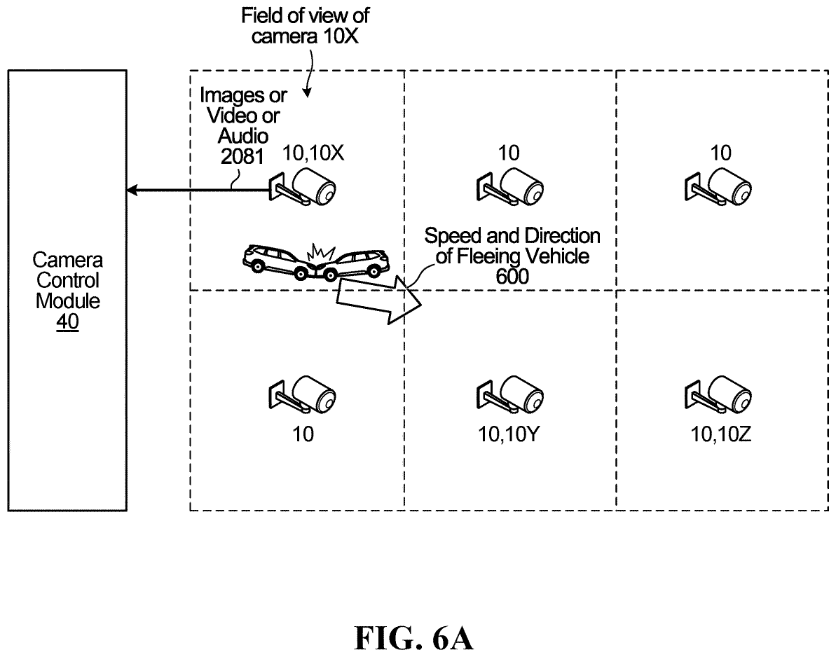

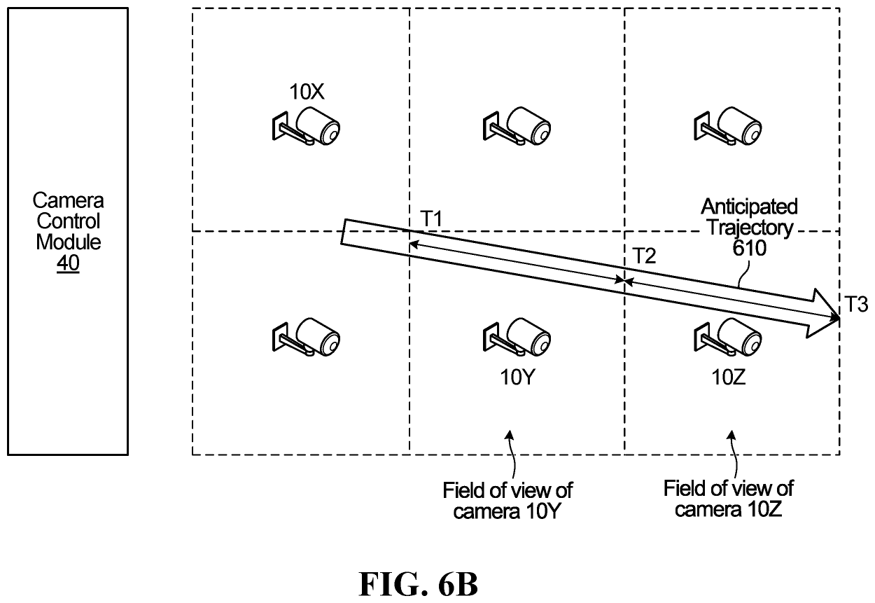

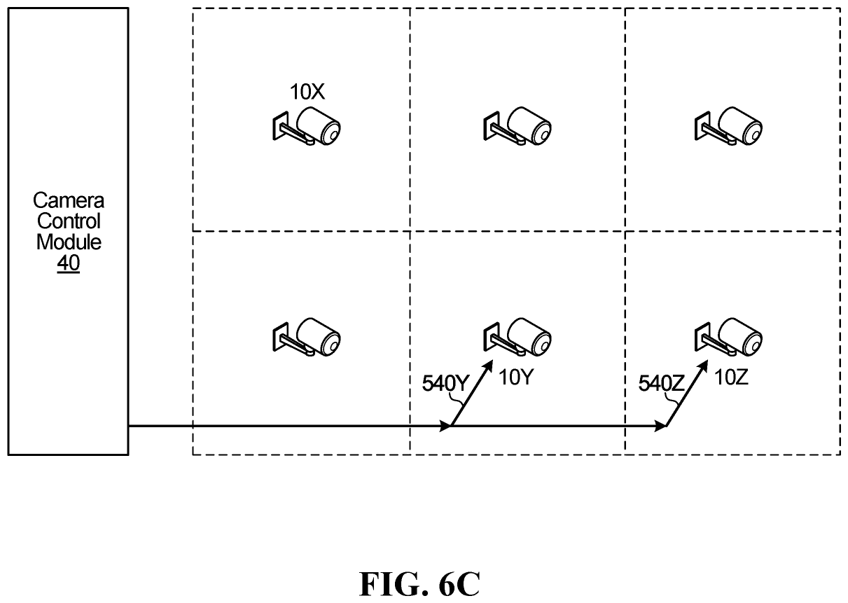

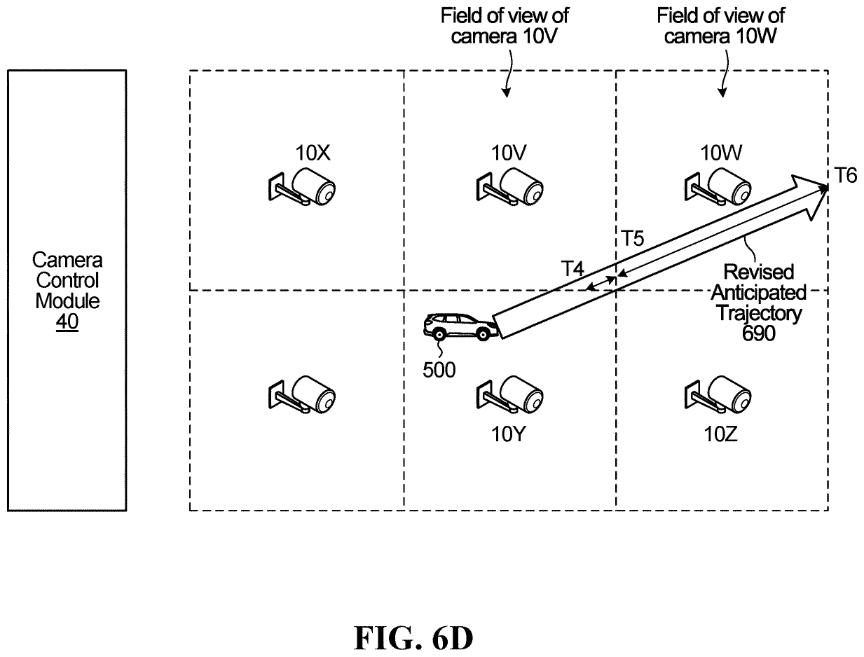

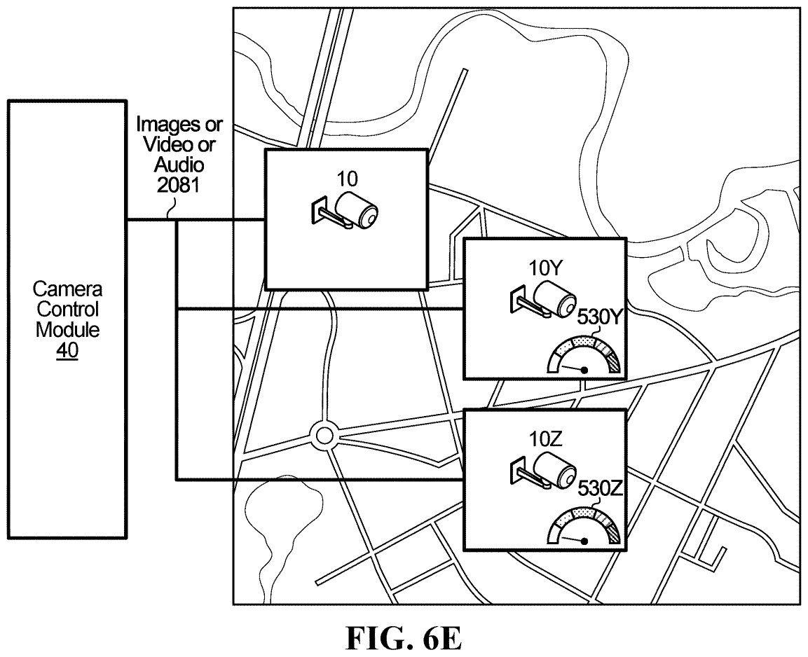

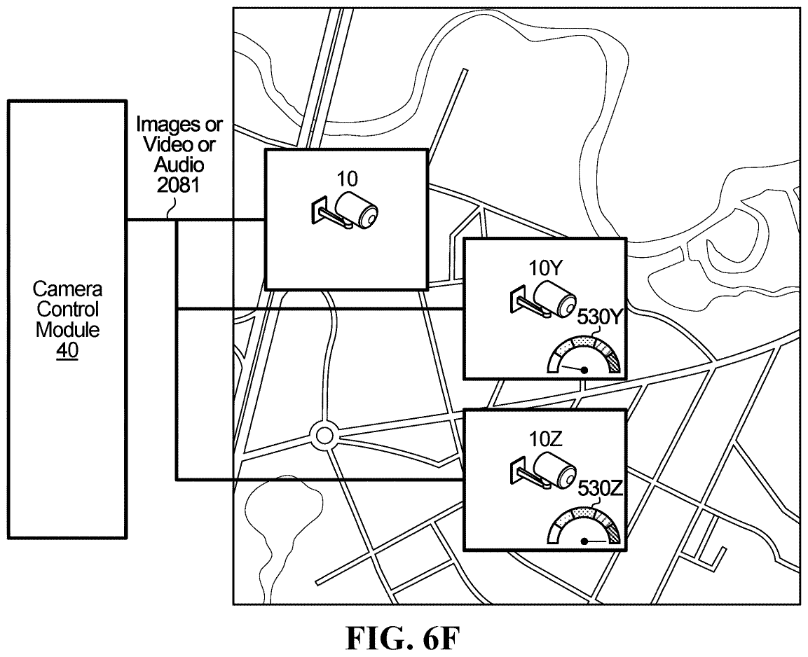

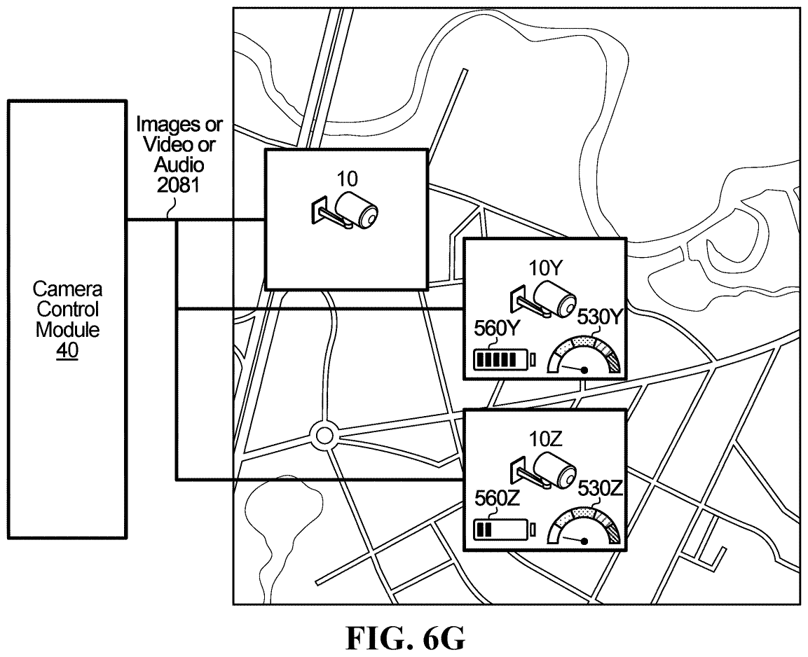

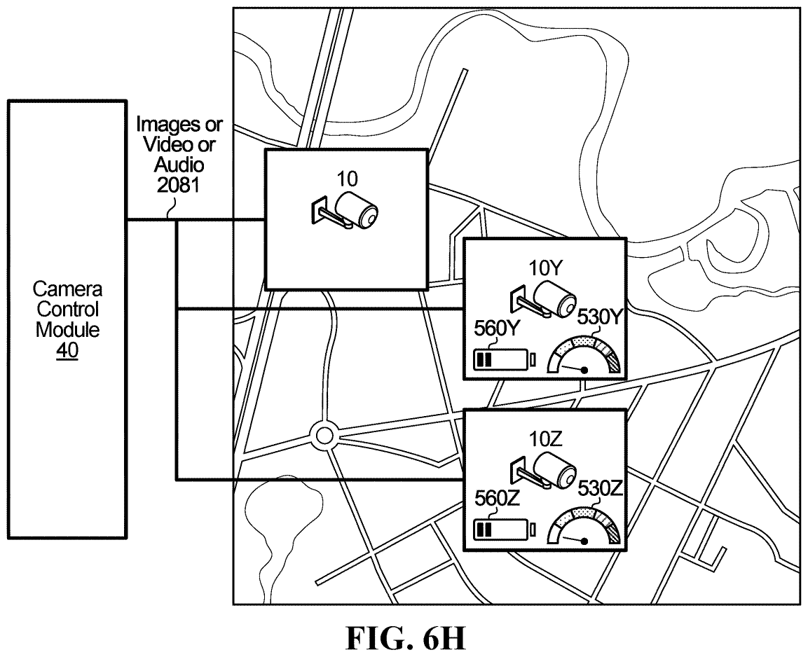

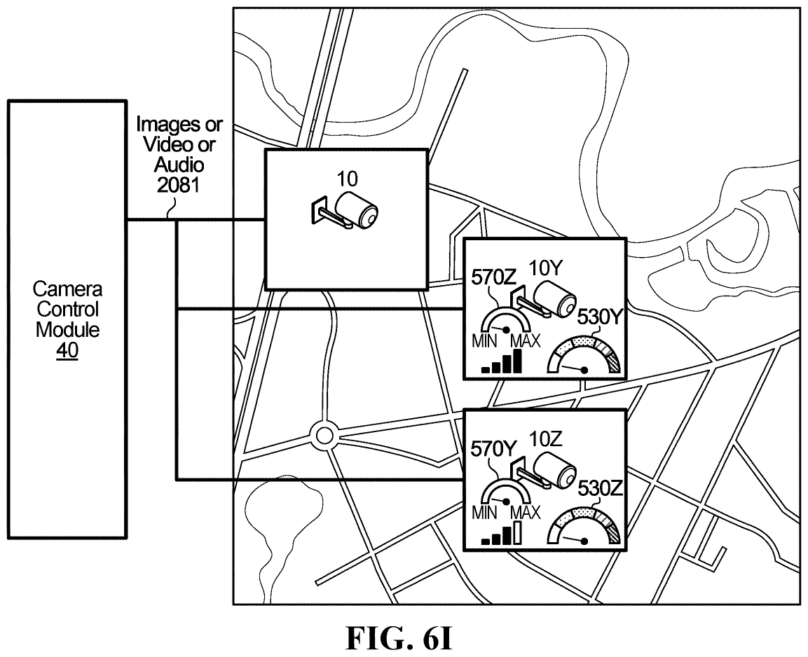

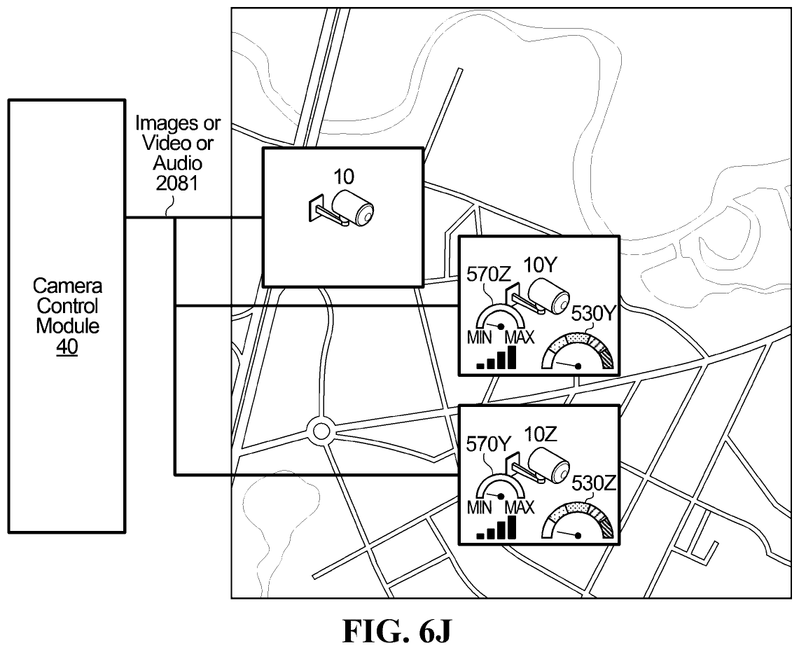

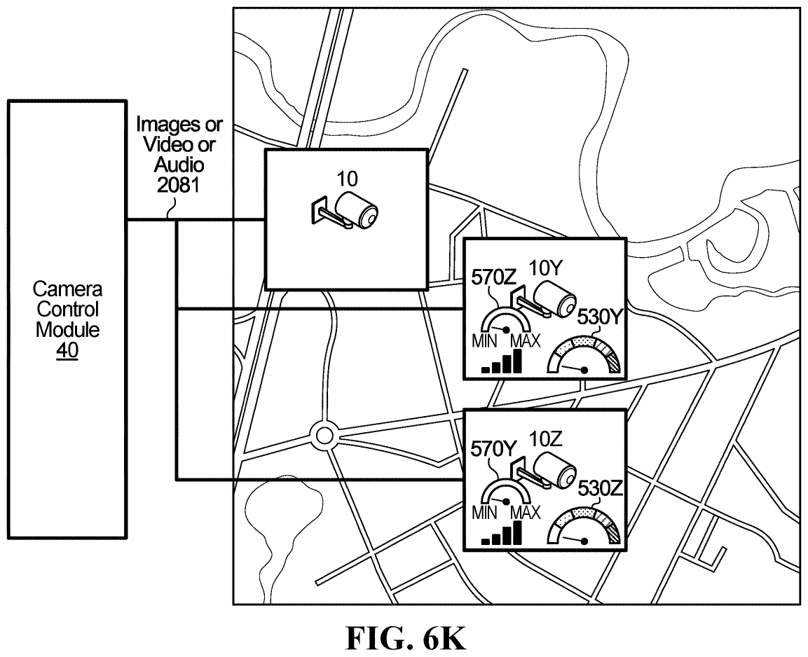

By way of non-limiting example, and with reference to FIG. 6A, consider that a traffic-related event occurs in the field of view of camera 10X. In this case, the traffic-related event is a vehicle collision. FIGS. 6B to 6D are conceptual representation of steps in a camera control process taking into consideration an anticipated trajectory of an object such as vehicle 600 involved in the vehicle collision shown in FIG. 6A.

In some embodiments, and with reference to FIG. 6B, the camera control module 40 may be configured to estimate an anticipated trajectory 610 of the vehicle 600 to select the target cameras from the set of one or more of cameras 10 based on the detected characteristics of the event. For example, the camera control module 40 may be configured to estimate, based on the direction and speed of the vehicle 600 determined by processing the images obtained from camera 10X, that the vehicle 600 is expected to enter the field of view of camera 10Y at time T1 and the field of view of camera 10Z at time T2. The camera control module 40 may also be configured to estimate that the vehicle 600 will exit the field of view of camera 10Y at time T2 and will exit the field of view of camera 10Z at time T3. Cameras 10Y and 10Z can thus be referred to as the target cameras in this example.

It is also within the scope of this disclosure to switch camera 10X itself (the camera that originally captured the event) into high resource consumption mode if it happens to have been in low resource consumption mode of operation when the event characteristic was detected, and if the event is associated with sufficiently slow moving targets that there is a good chance of extracting valuable information from the images captured by camera 10X after the event. In other words, the camera 10 used to detect the event may be considered a target camera as well, in some embodiments.

Accordingly, and with reference to FIG. 6C, the camera control module 40 may be configured to send a command 540Y, 540Z to cameras 10Y, 10Z, respectively, to cause the cameras 10 switch into high resource consumption mode of operation. It is noted that the commands 540Y, 540Z need not be sent immediately upon determining that a change in the resource consumption mode of operation is desired. In fact, it is noted that due to the anticipated trajectory 510, if camera 10Y were to be switched to high resource consumption mode of operation, this would need to occur at or around time T1, and in the case of camera 10Z, a switch to high resource consumption mode of operation would need to occur at or around time T2. Moreover, as the vehicle 600 is not expected to be in the field of view of camera 10Y after time T2, camera 10Y can switch back to its previous mode of operation at time T2 and, similarly, camera 10Z can switch back to its previous mode of operation at time T3. This could help the rate at which the battery charge level of camera 10Y or camera 10Z is being depleted, once the images, videos, and/or audio 2081 pertaining to the event are no longer expected to be in the respective camera's field of view.

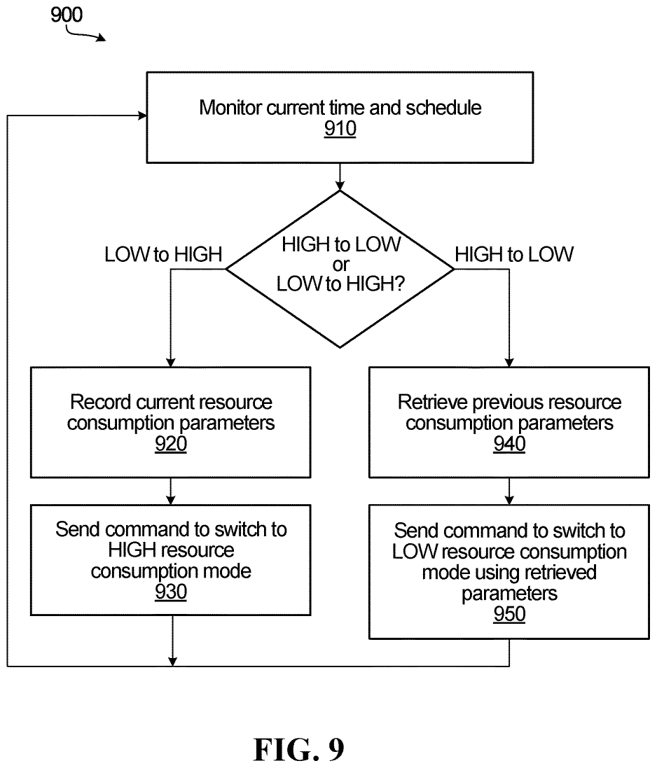

Accordingly, to manage the transmission of commands to the target cameras at different times in the future, an alternate embodiment of the camera control process 400 could include filling a schedule 90 stored in non-transitory memory and accessible to the camera control module 40. Specifically, the schedule 90 could include the identification of each target camera (e.g., camera 10Y or camera 10Z), as well as the start time when that target camera is to enter a high resource consumption mode of operation and a stop time when that camera can return to its previous settings. For example, referring to the situation in FIG. 3, camera 10Y is associated with a switch to high resource consumption mode of operation at time T1 and a switch back into a low resource consumption mode of operation at time T2. The schedule 90 could also store the previous settings of each target camera 10 before it was switched into the high resource consumption mode of operation, so as to facilitate the switch back to its previous mode of operation. Transmission of the commands 540Y, 540Z can then be managed by a command dispatch process 600 that may run in parallel with the camera control process 400. The command dispatch process 900, which may also be run by the camera control module 40, is now described with reference to the flowchart in FIG. 9.

In particular, at step 910, the command dispatch process 900 continuously monitors the current time and the schedule 90, and when the time to switch a particular camera into high or low resource consumption mode of operation has been reached, the command dispatch process proceeds to step 920 (for a switch into high resource consumption mode) or step 940 (for a switch into low resource consumption mode). Specifically, at step 920, the command dispatch process 900 records the current operating parameters of the particular camera and stores them in the schedule 90 and, at step 900, sends a command to the particular camera to cause the camera to enter into a high resource consumption mode of operation. In contrast, when step 940 is entered for the particular camera, the command dispatch process 900 retrieves the previous operating parameters of the particular camera from the schedule 90 and, at step 950, sends a command to the particular camera to cause the camera to restore its previous parameters associated with a low resource consumption mode.

If cameras 10Y and 10Z are already operating in high resource consumption mode of operation, then there is no need to change the operational state of the cameras 10Y, 10Z, although it should be ensured that camera 10Y continues to operate in high resource consumption mode between times T1 and T2 and that camera 10Z continues to operate in high resource consumption mode between times T2 and T3.

In the above embodiments, the timing of the switch back to low video resource consumption mode for each target camera was determined based on detection of the event and the anticipated trajectory 610. In other words, upon detection of the event, the camera control module 40 was configured to estimate a first time instant when a target camera should be switched into high resource consumption mode and a second time instant when the target camera should be switched back into low resource consumption mode in order to conserve power. As mentioned above, this information can be stored in the schedule 90. However, it will be appreciated that the values of the first and second time instants can be changed over time, such as based on new information.

For example, in the non-limiting embodiment of FIGS. 6A and 6B, the vehicle 600 is expected to pass through the field of view of camera 10Y between times T1 and T2 and then through the field of view of camera 10Z between times T2 and T3. However, once the vehicle 600 is in the field of view of camera 10Y, it is possible that the vehicle 600 changes course. Since the images from camera 10Y are being monitored for a vehicle 600 that entered the field of view of camera 10Y at around time T1, it is possible for the camera control module 40 to detect the vehicle 600 and, more specifically, to detect that the vehicle 600 has changed course. As such, and with reference to FIG. 6D, the camera control module 40 may be configured to detect that the vehicle 600 has adopted a revised anticipated trajectory 690, which is in this case associated with newly identified target cameras 10V and 10W. Specifically, the revised anticipated trajectory 690 is associated with entry of the vehicle 600 into the field of view of camera 10V at time T4 and exit from camera 10V's field of view at time T5, as well as entry into the field of view of camera 10B at time T5 and exit from camera 10B's field of view at time T6. As a result of this new computation of the revised anticipated trajectory 690, the camera control module 40 may be configured to delete the information in the schedule 90 that was associated with camera 10Z, as the vehicle 600 is no longer expected to pass through the field of view of camera 10Z, i.e., camera 10Z is no longer a target camera. As such, the set of target cameras 10 associated with the same event can dynamically change over time. That is to say, the change in trajectory of the vehicle 600 does not necessarily represent a new event, although it may be considered a new event if the change in trajectory meets the criteria of an event whose characteristics would be detected by execution of step 420 of the camera control process 400 (e.g., if the change in trajectory resulted after a new speeding violation was detected).

In view of the foregoing, the schedule 90 for a given target camera may include dynamically changing switch times from low to high resource consumption mode of operation and from high to low resource consumption mode of operation, based on dynamic progression of the event, which can be determined by processing of the images, videos, and/or audio 2081 received from the given target camera 10 and other cameras, some of which may not be target cameras 10 or by the server 20.

However, those skilled in the art will appreciate that in some cases, the schedule 90 might only include the start time of switching certain target cameras from low to high resource consumption mode of operation, without specifying when those target cameras 10 are to be switched back into low resource consumption mode. In particular, the length of time during which a particular target camera is to stay in high resource consumption mode may be fixed, or may depend on its battery charge level and/or its data consumption level. That is to say, once it has been decided to switch a particular target camera 10 into high resource consumption mode of operation further to occurrence of an event, the decision to switch it back into low resource consumption mode of operation may be made after X minutes or seconds, where X may be fixed or may depend on factors intrinsic to the particular camera, such as battery charge level or data consumption level. For instance, a camera that has between 50% and 75% battery charge level when it is being instructed to switch from low to high resource consumption mode may remain in high resource consumption mode for 5 minutes, whereas a camera that has between 75% and 100% battery charge level when it is being asked to switch from low to resource consumption mode may remain in high resource consumption mode for 10 minutes.

In still other embodiments, the decision to switch a given target camera back to low resource consumption mode of operation may be made based on processing the images, videos, and/or audio 2081 received from the given target camera. For example, with reference to FIG. 6D, if vehicle 600 is being tracked within the field of view of camera 10V after camera 10V was switched into high resource consumption mode, then if vehicle 600 disappears from the field of view of camera 10V (as determined by the camera control module 40 processing images received from camera 10V), this would be an indication that camera 10V no longer needs to operate in high resource consumption mode of operation. This same conclusion can be reached it the vehicle 600 is detected in the field of view of another camera that does not intersect with the field of view of camera 10V. In this case, the camera control module 40 can send a command to instruct camera 10V to revert back to low resource consumption mode of operation and may retrieve from the schedule 90 the parameters formerly used by camera 10V.

In some embodiments, the resource consumption parameters used by a target camera 10 in low resource consumption mode of operation before it is switched to high resource consumption mode are not stored in the schedule 90 but rather are recorded by the target camera 10 itself, so that all that is required to switch the target camera into low resource consumption mode of operation is a command to do so, and the resource consumption parameters used to operate in low resource consumption mode of operation will be known and available to the camera 10.

Camera Control Process Taking into Consideration a Camera Control Policy

In one embodiment, at step 530 of the dynamic change process 500, the decision as to whether to change the resource consumption mode of operation of the target cameras 10 may be made as a function of a camera control policy 285 stored in the policy database 60. The camera control policy 285 may consider the resource consumption mode of operation in which cameras 10 are currently operating (which would be known from the resource consumption parameters stored in the parameter database 80). FIGS. 6E to 6J are conceptual representation of steps in a camera control process taking into consideration a camera control policy 285. As shown FIG. 6E, cameras 10Y and 10Z were selected to be target cameras in step 520 of the dynamic change process 500 (which is part of the camera control process 400).

For instance, and in accordance with one embodiment of the camera control policy, the camera control module 40 may be configured to control operating functions of all target cameras 10 that were found to be operating in low resource consumption mode of operation so as to increase the transmissibility or the extractability of the images, videos, and/or audio 2081 generated by these target cameras 10. In the example shown in FIG. 6E, this would include camera 10Y and camera 10Z, as demonstrated by conceptual quality gauges 530Y, 530Z which are indicative of low resource consumption mode of operation. Accordingly, the camera control module 40 may be configured to send a command 540Y, 540Z to cameras 10Y, 10Z, respectively, to cause the cameras 10 switch into high resource consumption mode of operation (as was similarly depicted in FIG. 6C).

However, in this embodiment, just because a target camera is operating in low resource consumption mode does not mean that it should be switched into high resource consumption mode of operation. In fact, in this embodiment, this depends on the camera control policy, and according to some camera control policies, the camera control module 40 may deem it sufficient to ensure that only a single one of the target cameras 10Y, 10Z operate in high resource consumption mode. As such, consider the situation shown in FIG. 6F, where camera 10Y is in low resource consumption mode and camera 10Z is in high resource consumption mode of operation (as evidenced by the conceptual quality gauges 530Y, 530Z), then no further action needs to be taken. However, if neither camera 10Y nor camera 10Z is in the high resource consumption mode of operation (as was the case in FIG. 6E), then either camera 10Y or camera 10Z could be switched into high resource consumption mode of operation by sending either command 540Y or command 540Z.

The criteria for switching target cameras into high resource consumption mode of operation can be encoded in the camera control policy stored in the policy database 60, and can be a function of each target camera's battery charge level and/or data consumption level, resource consumption mode of operation, as well as event/severity, overall number of target cameras associated with the event and proximity of the target cameras to the event, to name a few non-limiting possibilities.

In one example of implementation of this embodiment, the policy takes into consideration the battery charge level of the target cameras 10Y and 10Z. For example, it is possible that camera 10Y and camera 10Z are both operating in low resource consumption mode of operation but the battery of camera 10Y may have a low battery charge level (e.g., below a threshold), whereas the battery of camera 10Z may have a high battery charge level (e.g., above a threshold). In this case, the low resource consumption mode of operation is a low power consumption mode of operation. This is illustrated in FIG. 6G, where conceptual battery level gauges 560Y and 560Z show the respective battery charge levels of cameras 10Y and 10Z. In this case, since the battery charge level of camera 10Z is low, it may be desirable to not further deplete the replenishable power supply 212 of camera 10Z as a result of switching it into high power consumption mode. As such, the camera control module 40 may be configured to not change the operating function of camera 10Y, and to only switch camera 10Z it into high power consumption mode of operation. This can be done by sending command 540Z to camera 10Z.

For example, consider that both camera 10Y and camera 10Z are operating in low power consumption mode and have a low battery charge level, as illustrated in FIG. 6H. In this case, the camera control module 40 may determine, depending on the event and the camera control policy, that one or both of the cameras 10Y, 10Z are to be switched into high power consumption mode of operation despite the fact that this will further deplete their relatively low battery charge levels. This could be the case where the detected event is considered to have a serious event (e.g., a shooting or an assault), as defined in the camera control policy.

A scenario may arise wherein there is seemingly forced operation in low power consumption mode (due to a low battery charge level and the control policy indicating that the camera 10 should operate in low power consumption mode) at the same time as a decision to change to mode of operation to high power consumption mode (due to a detected event characteristic). In one embodiment, this apparent contradiction can be resolved by the camera control module 40 consulting a policy 285 stored the memory 208. The policy 285 outlines various possibilities and priorities for determining the exact conditions under which forced operation in high power consumption mode will prevail versus those under which forced operation in lower power consumption mode will prevail. In another embodiment, the server 20 may be configured to override the policy 285 and force the camera to operate in high power consumption mode even if the control policy 285 indicates that the camera 10 should operate in low power consumption mode.

In another example of implementation of this embodiment, the policy takes into consideration the data consumption level of the target cameras 10Y and 10Z. For example, it is possible that camera 10Y and camera 10Z are both operating in low resource consumption mode of operation but the camera 10Z may have a high data consumption level (e.g., above a threshold), whereas the battery of camera 10Y may have a low (or lower) data consumption level (e.g., below a threshold). In this case, the low resource consumption mode of operation is a low data consumption mode of operation. This is illustrated in FIG. 6I, where conceptual data consumption level gauges 570Y and 570Z show the respective data consumption levels of cameras 10Y and 10Z. In this case, since the data consumption level of camera 10Z is high, it may be desirable to configure camera 10Z to not further consume data as a result of switching it into high data consumption mode. As such, the camera control module 40 may be configured to not change the operating function of camera 10Z, and to only switch camera 10Y it into high data consumption mode of operation. This can be done by sending command 540Y to camera 10Y.

Similarly, consider that both camera 10Y and camera 10Z are operating in low data consumption mode of operation and have consumed an amount of data that approaches the maximum data consumption level for a given period of time as illustrated in FIG. 6J. In this case, the camera control module 40 may determine, depending on the event and the camera control policy, that one or both of the cameras 10Y, 10Z are to be switched into high data consumption mode of operation despite the fact that this will further increase data consumption levels such that the data consumption may exceed the limit set. This could be the case where the detected event is considered a serious event (e.g., a shooting or an assault), as defined in the camera control policy.

A scenario may arise wherein there is seemingly forced operation in low data consumption mode (due to a data consumption level approaching or exceeding a threshold data consumption level and the control policy indicating that the camera 10 should operate in low data consumption mode) at the same time as a decision to change to mode of operation to high data consumption mode (due to a detected event characteristic). In one embodiment, this apparent contradiction can be resolved by the camera control module 40 consulting a policy 285 stored the memory 208. The policy 285 outlines various possibilities and priorities for determining the exact conditions under which forced operation in high data consumption mode will prevail versus those under which forced operation in lower data consumption mode will prevail. In another embodiment, the server 20 may be configured to override the policy 285 and force the camera to operate in high data consumption mode even if the control policy 285 indicates that the camera 10 should operate in low data consumption mode.

### Camera Network

In one embodiment, execution of the instructions stored in the memory 210 results in the processing system 200 of a camera 10N implementing the above-described camera control module 40 and camera control interface module 70. The camera 10N which will be referred to as instructing camera 10N is configured as the previously described camera 10.

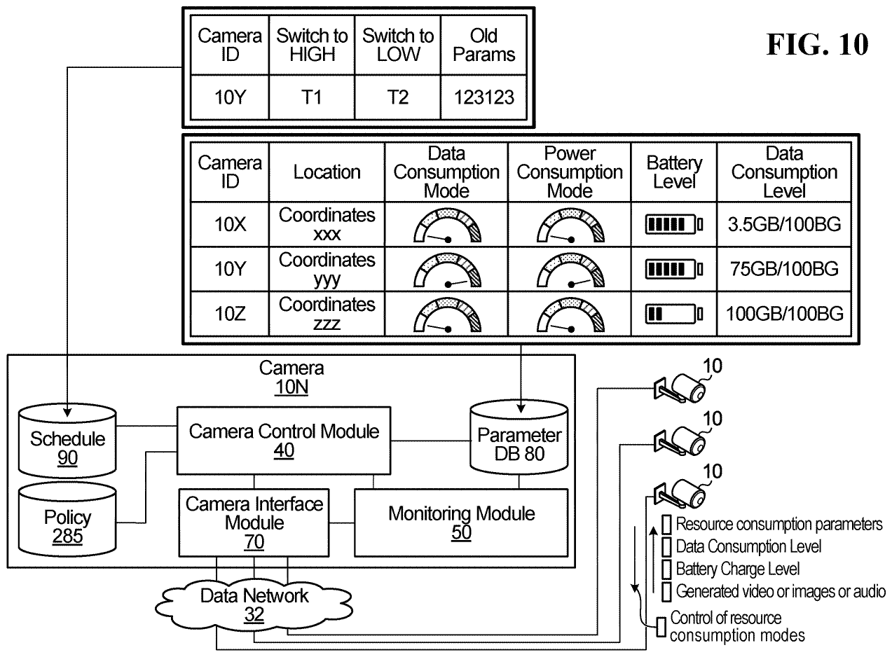

FIG. 10 is functional representation of the instructing camera 10N, including the camera control module 40, the monitoring module 50, the parameter database 80, the policy database 60 and the camera interface module 70 which have been previously described.

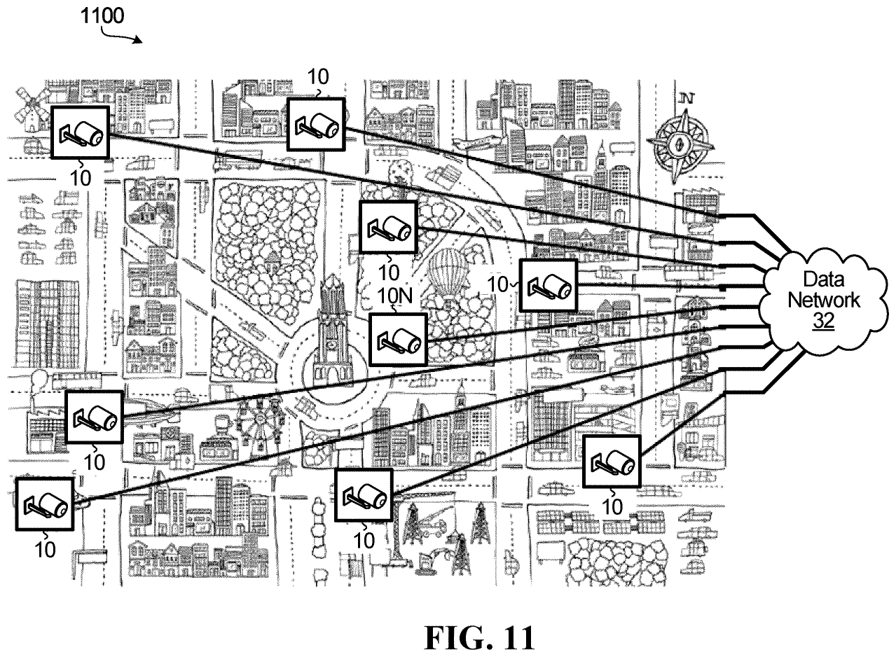

In this embodiment, the instructing camera 10N is communicatively coupled to one or more cameras 10. With reference to FIG. 11, there is shown a network of cameras 1100 including one or more cameras 10 and the instructing camera 10N. The instructing camera 10N is communicatively coupled to one or more cameras 10 and are connected via a data network 32. The data network 32 is a peer-to-peer network which provides for the cameras 10, 10N being communicatively coupled without the server 10. The cameras 10, 10N may communicate via longer range communication protocols (e.g. LoRa), or other suitable communication schemes such as WiFi.

The cameras 10, 10N may further be connected via the data network 30 to the camera control server 20.

The cameras 10, 10A are located remote from one another. In one embodiment, the cameras 10, 10N are located within a maximum threshold distance from one another so as to allow communication among the cameras 10, 10N. In some cases, the maximum threshold distance may be 5 kilometers (km), in other cases 3 km, in other cases 1 km. It is understood that greater threshold distances may be possible.

In this embodiment, the processing device 202 of the instructing camera 10N performs the functions of the server 10 as it relates to the camera control process 400 and the dynamic change process 500.

In this embodiment, a target camera is selected from the cameras 10 based on an event characteristic detected by the camera 10N. Detection of an event characteristic by the camera 10N is carried out similarly as the detection of an event characteristic by the server 20 described above.

Those skilled in the art will also appreciate that although only two resource consumption modes are described, namely low resource consumption mode and high resource consumption mode, this has been done for simplicity and that resource consumption may be expressed in a more granular way. Similarly, battery charge levels and data consumption levels may be expressed more granularly. The increased number of possibilities for the battery charge levels, data consumption levels and resource consumption modes may allow more sophisticated camera control policies covering a range of possible scenarios that may arise and leading to even more optimal power savings and even more optimal audiovisual generation attributes such as transmissibility or extractability.

Although the present disclosure sometimes describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, systems, software or any combination of the two.

Accordingly, certain technical solutions of the present disclosure may be embodied in the form of a software product. A suitable software product may be stored in a pre-recorded storage device or other similar non-volatile or non-transitory computer readable medium, for example. The software product includes instructions tangibly stored thereon that enable a processing system or device (e.g., a microprocessor) to execute examples of the methods disclosed herein.

Additionally or alternatively, certain technical solutions of the present disclosure may be embodied in the form of a system (e.g., an audiovisual system). A suitable system includes one or more hardware components. In some cases, the system includes a processing system or device (e.g., a microprocessor) configured to execute examples of the methods disclosed herein. The processing device may be enabled to execute examples of the methods disclosed herein based on instructions which may be stored on a suitable hardware component such as an instruction memory.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

Although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method of operating a computing apparatus communicatively coupled to a set of one or more cameras, comprising:
monitoring a resource consumption mode of operation each of the cameras; and
changing the resource consumption mode of operation of one or more target cameras in the set of one or more cameras from a first resource consumption mode of operation to a second resource consumption mode of operation, the target cameras being selected based on an event characteristic detected by the computing apparatus, the first resource consumption mode of operation being a low resource consumption mode of operation and the second resource consumption mode of operation being a high resource consumption mode of operation.

2. The method of claim 1, wherein each of the cameras in the set of one or more cameras comprises:
an audiovisual (AV) generation system configured to generate at least one of images or videos or audio, the AV generation system comprising at least one of an image capture device configured to capture images or an audio capture device configured to capture audio, the AV generation system further comprising a processing entity configured to process at least one of the captured images or the captured video or the captured audio; and
a network interface operable to transmit to the computing apparatus at least one of the images or videos or the audio generated by cameras in the set of one or more cameras.

3. The method of claim 2, wherein the one or more target cameras include at least one of an on-grid camera or an off-grid camera.

4. The method of claim 3, wherein the low resource consumption mode of operation is a low data consumption mode of operation and the high resource consumption mode of operation is a high data consumption mode of operation.

5. The method of 4, wherein when a given one of the one or more target cameras is in the high data consumption mode, the given one of the one or more target cameras consumes more wireless data than in low data consumption mode.

6. The method of claim 5, wherein the network interface of the given one of the one or more target cameras is operable to transmit to the computing apparatus at least one of (i) images generated by the given one of the one or more target; (ii) videos generated by the given one of the one or more target; or (iii) audio generated by the given one of the one or more target, in accordance with at least one data consumption parameter that affects wireless data utilization by the given one of the one or more target cameras.

7. The method of claim 6, wherein the at least one data consumption parameter comprises at least one of a data transmission setting indicative of whether real-time data transmission to the computing apparatus is enabled, a data consumption setting indicative of whether wireless data consumption is enabled, a threshold limit for an amount of data consumable over a given time period, bandwidth, transmission duty cycle, modulation scheme, data rate and latency.

8. The method of claim 7, wherein changing the resource consumption mode of operation from a low data consumption mode of operation to a high data consumption mode of operation comprises at least one of (i) decreasing a latency used by the network interface to transmit the generated images or audio to the computing apparatus (ii) enabling real-time data transmission to the computing apparatus or wireless data consumption by the network interface to transmit the generated images or videos or audio to the computing apparatus (iii) increasing a threshold limit for an amount of data consumed over a given time period, a bandwidth, a transmission duty cycle and/or a data rate used by the network interface to transmit the generated images or videos or audio to the computing apparatus; or (iv) changing a modulation scheme used by the network interface to transmit the generated images or videos or audio to the computing apparatus.

9. The method of claim 2, wherein the one or more target cameras are off-grid cameras.

10. The method of 9, wherein each off-grid camera includes a replenishable power supply.

11. The method of claim 10, wherein the replenishable power supply comprises an off-grid power supply.

12. The method of claim 11, wherein the low resource consumption mode of operation is a low power consumption mode of operation and the high resource consumption mode of operation is a high power consumption mode of operation.

13. The method of claim 12, wherein when a given one of the one or more target cameras is in the high power consumption mode of operation, the given one of the one or more target cameras consumes more power from the off-grid power supply than during the low power consumption mode of operation.

14. The method of claim 12, wherein when a given one of the one or more target cameras is in the lower power consumption mode of operation, the given one of the one or more target cameras is configured to capture still images; and when the given one of the one or more target cameras is in the high power consumption mode of operation, the given one of the one or more target cameras is configured to capture video.

15. The method of claim 13, wherein the AV generation system of the given one of the one or more target cameras is operable to generate at least one of images or videos or audio in accordance with at least one power consumption parameter that affects power utilization by the given one of the one or more target cameras.

16. The method of claim 15, wherein the at least one power consumption parameter comprises at least one of an image capture activation setting indicative of whether image or video capture is enabled, an audio capture activation setting indicative of whether audio capture is enabled, frame rate, image resolution, number of images captured over a given time period, activation of flash, a brightness of flash, a sampling rate, a detection rate, a compression ratio, and a threshold limit of acceptable false positive detections.

17. The method of claim 16, wherein changing from a low power consumption mode of operation to a high power consumption mode of operation comprises at least one of (i) enabling image capture, enabling video capture, enabling audio capture; (ii) increasing a frame rate, an image resolution, a number of images captured over the given time period, a brightness of flash, an activation of flash, and/or a sampling rate used by the AV generation system to generate images or videos or audio; (iii) increasing a detection rate or the threshold limit of acceptable false positive detections used by the processing entity to process the generated images or the generated videos or the generated audio; or (iv) decreasing a data compression ratio used by the AV generation system to generate images or videos or audio.

18. The method of claim 12, wherein the processing entity of a given one of the one or more target cameras is configured for carrying out first-level processing of captured images or videos or audio to create a result, wherein when the given one of the one or more target cameras is in the high power consumption mode of operation, the processing entity is configured for performing second-level processing on the result of the first-level processing and for sending a result of the second-level processing to the computing apparatus via the wireless network interface, and wherein when the given one of the one or more target cameras is in the low power consumption mode of operation, the processing entity is configured for sending the result of the first-level processing to the computing apparatus via the wireless network interface without performing the second-level processing on the result of the first-level processing.

19. The method of claim 2, wherein the event characteristic is detected by the computing apparatus based on at least one of: (i) responding to contents of images or videos or audio captured by a given one of the cameras in the set of one or more cameras; (ii) responding to a result received from a given one of the set of one or more cameras, the result created by the given one of the cameras in the set of one or more cameras further to the processing entity of the given one of the cameras in the set of one or more cameras carrying out processing of captured images or captured video or captured audio; or (iii) responding to a backend input received by the computing apparatus.

20. The method of claim 19, wherein the result comprises a license plate detection, an object detection or a gunshot detection.

21. The method of claim 19, wherein the backend input comprises an input indicative of a computer-aided dispatch call, a call received from an emergency service or an AMBER (America's Missing: Broadcast Emergency Response) Alert.

22. The method of claim 2, wherein the event characteristic detected by the computing apparatus includes one of a location, a location of an object, a direction of travel of an object and a speed of travel of an object.

23. The method of claim 22, wherein the target cameras are those cameras of the set of one or more cameras whose field of view or whose pickup range is in within a threshold distance of the location or of the object.

24. The method of claim 1, wherein changing the resource consumption mode of operation of a given one of the one or more target cameras is carried out irrespective of a battery charge level of the given one of the one or more target cameras.

25. The method of claim 1, wherein changing the resource consumption mode of operation of a given one of the one or more target cameras is carried out irrespective of a data consumption level of the given one of the one or more target cameras.

26. The method of claim 1, wherein the method further comprises, for a given one of the one or more target cameras, changing the resource consumption mode of operation from the high consumption mode of operation to the low consumption mode of operation based on a relinquish condition determined to having been met by the computing apparatus and controlling at least one resource consumption parameter of the given one of the one or more target cameras to change the resource consumption mode of operation from the high consumption mode of operation to the low consumption mode of operation.

27. The method of claim 26, wherein the relinquish condition having been met comprises a given amount of time having elapsed.

28. The method of claim 1, further comprising receiving an input from a given one of the one or more target cameras indicative of a change from the high consumption mode of operation to the low consumption mode operation further to a determination by the given one of the one or more target cameras that a relinquish condition has been met and updating a resource consumption mode database stored in a memory of the computing apparatus.

29. The method of claim 2, wherein the event characteristic detected by the computing apparatus is an anticipated trajectory of at least one object, wherein the one or more target cameras are those cameras in the set of one or more cameras whose field of view is traversed by the anticipated trajectory.

30. The method of claim 29, further comprising computing a scheduled time at which to change the resource consumption mode for each of the one or more target cameras.

31. The method of claim 30, wherein changing the resource consumption mode of operation of the one or more target cameras comprises sending a command to the each of the one or more target cameras to change the resource consumption mode of operation at the scheduled time.

32. The method of claim 31, wherein the method further comprises monitoring images or video or audio generated by a given one of the one or more of target cameras to determine if a condition is met and sending a command to the given one of the one or more target cameras to change the resource consumption mode of operation from the high resource consumption mode of operation to the low resource consumption mode of operation if the condition is met.

33. The method of claim 32, wherein the condition comprises the object no longer being in the field of view of the given one of the one or more target cameras.

34. A non-transitory computer-readable medium storing instructions which, when read and executed by a processor of a computing apparatus communicatively coupled to a set of one or more cameras, cause the processor to carry out a method that comprises:
monitoring a resource consumption mode of operation of each of the cameras; and
changing the resource consumption mode of operation of one or more target cameras in the set of one or more cameras from a first resource consumption mode of operation to a second resource consumption mode of operation, the target cameras being selected based on an event characteristic detected by the computing apparatus, the first resource consumption mode of operation being a low resource consumption mode of operation and the second resource consumption mode of operation being a high resource consumption mode of operation.

35. A computing apparatus communicatively coupled to a set of one or more cameras, the computing apparatus comprising:
a processor; and
memory including program code that, when executed by the processor, causes the processor to:
monitor a resource consumption mode of operation of each of the cameras; and
change the resource consumption mode of operation of one or more target cameras in the set of one or more cameras from a first resource consumption mode of operation to a second resource consumption mode of operation, the target cameras being selected based on an event characteristic detected by the computing apparatus, the first resource consumption mode of operation being a low resource consumption mode of operation and the second resource consumption mode of operation being a high resource consumption mode of operation.
